(19) United States
(12) Patent Application Publication
(10) Pub. No.: US 2017/0013810 A1
(43) Pub. Date: Jan. 19, 2017

(54) PORTABLE AGRARIAN BIOSYSTEM

(71) Applicants: Herb GRABELL, Long Beach, CA (US); Edward OBER, Pollock Pines, CA (US); Jeff TRIROGOFF, Moorpark, CA (US)

(72) Inventors: Herb GRABELL, Long Beach, CA (US); Edward OBER, Pollock Pines, CA (US); Jeff TRIROGOFF, Moorpark, CA (US)

(21) Appl. No.: 15/280,643

(22) Filed: Sep. 29, 2016

Related U.S. Application Data
(63) Continuation of application No. PCT/US16/23843, filed on Mar. 23, 2016.
(60) Provisional application No. 62/137,727, filed on Mar. 24, 2015.

(51) Int. Cl. A01K 63/00; C02F 3/32; A01K 63/04; A01G 31/06; A01K 63/06

(52) U.S. Cl. CPC A01K 63/003; A01G 31/06; A01K 63/065; A01K 63/045; A01K 63/047; C02F 3/32; A01G 2031/006

(57) ABSTRACT

A portable agrarian biosystem is a self-contained plant and fish growth facility encased in a shipping container so that it can be readily transported and set up. The system is designed for self-sufficient operation without connection to external sources of water or electricity. The modified aquaponic growth system is computer controlled for unattended operation with significantly lower consumption of water than other plant growth systems.

### CROSS-REFERENCE TO PRIOR APPLICATIONS

This application is a continuation of PCT/US16/23843, filed on 23 Mar. 2016, which was based on and claimed the benefit of U.S. Provisional Patent Application Ser. No. 62/137,727 filed 24 Mar. 2015.

### U.S. GOVERNMENT SUPPORT

Not applicable.

### BACKGROUND OF THE INVENTION

Area of the Art

The present invention is generally in the area of agronomy and aquaculture and is specifically directed to a self-contained plant and fish growth system.

Description of the Background Art

U.S. Pat. No. 5,046,451 to Inslee et al. describes a combination hydroponic greenhouse and fish farm system. U.S. Pat. No. 6,233,870 to Horibata describes a system and device for using aquaculture in a building. U.S. Pat. No. 8,181,391 to Giacomantonio describes a vertical aquaponic micro-farm. U.S. Pat. No. 8,677,942 to Bodlovich et al. described an aquaponic system. WO 2012/72273 to Dicks describes a plant growth chamber. U.S. Pat. No. 9,089,113 to Jacobs describes a food production module within a shipping container. U.S. Pat. No. 9,032,665 to Whitney describes a vertical aquaponic garden with air filtration properties. Published U.S. Patent Application 2014/0259921 to Smallwood et al. describes another aquaponic system. Published U.S. Patent Application 2015/0196002 to Friesth describes a robotic aquaponic system. Published U.S. Patent Application 2015/0245569 to Villamar describes a combination solar greenhouse and aquaponic system.

Many of these prior art references deal with aquaponics and to that extent are on point with the present invention. However, these references do not disclose or suggest a self-contained growth system having the features of the present invention. Like the present invention the device of Jacobs, mentioned above, is designed to fit within a shipping container. However, Jacobs lacks many features of the present invention including those that allow long term, continuous operation off the grid independent of typical domestic water systems or supplies.

### SUMMARY OF THE INVENTION

The PABS (Portable Agrarian Bio-System) is a sustainable and self-sustaining, self-contained, portable hybrid aquaponic/hydroponic, indoor controlled-environment biosystem for harmoniously growing fish and plants with minimal system inputs. It can be deployed virtually anywhere in the world and can grow a large variety of plant and fish types with high quality and year-round operation. Its rugged and highly automatic design makes it easy to operate; it requires minimal attendance by people. Its ability to accept multiple power inputs makes it capable of global applications, working off-grid in multiple climatic environments. The system design minimizes water consumption and maximizes recycling of all elements by maintaining a carefully balanced biosystem. The PABS is designed for off-grid use for multiple applications enhancing “Food” and “Energy” security and to minimize operating costs and maximize deployability. It comes standard with a self-contained power system (“Microgrid”), as well as rainwater capture, atmospheric water generation and water storage capabilities that in combination makes it suitable for year-round deployment in locations without community infrastructure support (i.e. power grid, water infrastructure, etc.). The combination of water capture, generation and storage in conjunction with renewable power generation and storage allows this system to be the first portable, sustainable, off-grid and self-sustaining hybrid aquaponic/hydroponic biosystem.

### DESCRIPTION OF THE FIGURES

FIG. 1 is a two-dimensional illustration of the full exterior view of the system from the front with doors removed to show interior;

FIG. 2 is a medium view illustration of the grow beds with a focus on the drain area and drain piping

FIG. 3 is different angle view illustration of the grow beds.

FIG. 4 is a close-up illustration of a grow bed equipped with a dual root-zone.

FIG. 5 is a close up illustration of the dispersion pipe assembly.

FIG. 6 is an illustration of the interior of the system northern grow bed showing the incubation rack as viewed from the front (east) looking northwest.

FIG. 7 is an illustration of the interior of the system from the west side looking east.

FIG. 8 is a two-dimensional illustration of the system with the shipping container removed to reveal the interior components from the south side.

FIG. 9 is an illustration showing the Fish Tank.

FIG. 10 is an illustration of the south west corner of the interior of the system where the nutrient injection system components are housed.

FIG. 11 is a perspective illustration of the exterior of the system showing the Atmospheric Water Generator.

FIG. 12 is a close-up illustration of the attachment of the Steel Enclosure for the Atmospheric Water Generator to the exterior side of the shipping container.

FIG. 13 is an illustration of the exterior of the system from the southwest corner.

FIG. 14 is an illustration of the exterior of the system from the southwest corner, showing the main exterior components of the water system.

FIG. 15 is an illustration of the southeast exterior corner of the system.

FIG. 16 is a close-up illustration of the multifunction port.

FIG. 17 is an illustration of the south west corner of the interior of the system viewed up from the floor inside the fish tank.

FIG. 18 is an illustration of the water pump and related components.

FIG. 19 is an illustration of the Interior Auxiliary Water Storage Tank.

FIG. 20 is an illustration of the interior northwest corner of the system.

FIG. 21 is an illustration showing the exterior of the system, focusing on the space between the shipping container and the Exterior Water Storage System.

FIG. 22 is an illustration of the interior of the system with selected components of the water system visible.

FIG. 23 is an illustration showing the floor drain p-trap.

FIG. 24 is an illustration of the plastic door curtain and micro-inverter junction box.

FIG. 25 is an illustration of the security system.

FIG. 26 is an illustration of the south west corner of the interior of the system.

FIG. 27 is an illustration of the air system (HVAC) components.

FIG. 28 is a diagram of the Environmental Control System.

FIG. 29 is an illustration from above of the interior of the system with the shipping container removed

FIG. 30 is an illustration of the Microgrid power system components.

FIG. 31 is a view from the southwest corner showing the Microgrid power system components.

FIG. 32 is an illustration of the interior of the system showing the energy storage devices.

FIG. 33 is an illustration of the side of the exterior of the shipping container showing the propane generator and the human-powered cycle.

FIG. 34 is a is an illustration of the underside of the platform on which the propane-generator and human-powered cycle reside.

FIG. 35 is an illustration of the north side of the exterior of the shipping container.

FIG. 36 is another close up illustration of the side of the exterior of the shipping container.

FIG. 37 is an illustration of a close up view of selected Microgrid components located under the south side grow bed.

FIG. 38 is an illustration of how the attachment of the Steel Enclosure for the Atmospheric Water Generator to the northeast corner of the exterior of the shipping container.

FIG. 39 shows the PV array adjusted to different seasonal angles.

FIG. 40 is an illustration showing a close-up of the PV mounting hardware.

FIG. 41 is an illustration of the west exterior of the system looking east showing the PV array.

FIG. 42 is a diagram of the Water System.

FIG. 43 is a diagram of the Security System.

FIG. 44 is an illustration of communications center cabinet.

FIG. 45 is a diagram of the communications system.

FIG. 46 is a diagram of the Microgrid Power System.

### DETAILED DESCRIPTION OF THE INVENTION

The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein specifically to provide a self-contained agrarian biosystem.

PABS and Aquaponics Introduction.

The Inventors have developed a sustainable, self-contained, self-sustaining and off-grid, Portable Agrarian Biosystem (“PABS”) based on the principles of the science of Aquaponics. The invention is sustainable because it is non-polluting, minimizes consumption, minimizes waste of resources and uses renewable energy; it is self-contained because all of its essential components are transported and operated inside or mounted onto a single container; it is self-sustaining because it provides its own renewable power and water generation and storage; it is off-grid because it needs no connection to community infrastructure; and, it is portable because it can be packed up and relocated virtually anywhere. Aquaponics is the combined culture of fish (and/or other aquaculture, hereinafter referred to as “fish”) and plants in recirculating systems, thereby creating an integrated ecosystem in which the fish waste mixes into the “fish water” (i.e., water in which the fish are living and into which they excrete waste) creating water with nutrients and organic matter. The fish waste (including ammonia and ammonium [NH₃ and NH₄]) in the water is processed by worms and bacteria living in the grow media to become nitrites (NO₂) and then into nitrates (NO₃), an ideal nutrient source for the plants/crops. The plants/crops, in turn, purify the fish water by taking up all the nutrients, minerals and other elements from the fish water; the system then recycles the clean water back to the fish. Worms are added by the user to the grow beds during cycling. Bacteria are naturally present everywhere, including water, in small amounts but will reproduce and develop significant colonies where their ideal nutrients and conditions are present. Ammonia is the key nutrient for our desired bacteria and therefore its presence will stimulate them. Aquaponics is a broad concept that can include many system types and designs, and generally does not require or use traditional soil, but it may utilize a variety of media types, or, in some system designs, no media at all. Not all aquaponic system designs are equal in ease of operation, effectiveness or yield. As examples, systems that use no media have very limited surface area for the bacteria to grow and therefore do not have the ideal environment to cultivate significant colonies of nitrifying bacteria; therefore, these systems will be much less effective at converting the fish waste into usable nutrients for plants than those systems with media. Moreover, systems that use deep water culture (DWC) or nutrient film technique (NFT) have the plant roots continually submerged in water, significantly reducing the amount of oxygen uptake possible by the roots. Even with added Dissolved Oxygen (DO) to the water, these systems frequently develop root rot and other plant health problems requiring significant attention to resolve. In contrast, the PABS unit is designed with media beds that can simultaneously utilize a variety or even multiple media types. Plants are grown in the selected medium/media, which is periodically flooded with the fish water. The plants take up the dissolved nutrients that are directly excreted by fish or generated from the microbial breakdown of fish waste as previously described (see “Recirculating Aquaculture 3^{rd} Edition”). The water then drains back into the fish tank. The PABS unit is designed with a Flood-and-Drain system that maximizes the amount of oxygen uptake of the roots since there is a higher concentration of oxygen in the air than in the water. The timing of the Flood-and-Drain cycle can be adjusted by the PABS user but the recommended setting if all eight grow beds are in use is to provide plants in each grow bed with 7.5 minutes of flooding per hour followed by 52.5 minutes of root exposure to air before repeating the cycle. This recommended setting ensures that each grow bed is fed every hour, but users may adjust the cycle timing. Aquaponic systems on average use 90% less water than traditional outdoor soil-based agricultural practices, and 50% less water than hydroponic agriculture (indoor or outdoor). (See: “Water and Energy Conservation Grow System: Aquaponics and Aeroponics with a Cycle Timer”; “Aquaponics Research Project”; “Water Usage in Recirculating Aquaculture/Aquaponic Systems.) Water loss paths in traditional agriculture include diffusion in soil (vertical as well as horizontal), soil water evaporation, evapotranspiration and plant retention. Other major losses result from transmission and delivery of irrigation water to the planted area. In hydroponics, the water becomes saturated with nutrients and unusable by the system after 7 to 30 days and must be discharged and replaced with fresh water; this also creates a disposal issue for the discharge water, as it cannot be safely disposed of outdoors. Aquaponics eliminates the majority of these loss paths associated with traditional agriculture and also eliminates the discharge issue associated with hydroponics. Recirculating systems ensure efficient water re-use, with no discharge. The enclosed, regulated environment of the PABS greatly reduces or eliminates evapotranspiration losses by reclaiming transpiration back into the system (and not lost to the atmosphere), stabilizes the relative humidity and promotes plant and fish health and growth. That leaves a significant majority (95% +) of water use dedicated to plant retention and recirculation.

PABS Hybrid Design.

Traditionally, aquaponics uses no chemical plant nutrient additives because the water is continuously recirculated between the fish and plants, and the chemical additives for plants would harm the fish. In a pure aquaponics system, all the nutrients for the plants are supplied entirely by the fish water. While the absence of any nutrient additives is workable, even ideal for many crops, some crops require nutrient additives for optimal plant health and yield and thus are not considered appropriate crops for aquaponics systems. The PABS changes this dynamic by offering a hybrid aquaponic/hydroponic system with a dual-root zone capability. With the PABS, the grower can choose to run a pure aquaponics system, a pure hydroponics system, or a hybrid aquaponic/hydroponic system throughout one, some or all of the grow beds, and can change setup if desired between harvest and replanting. The dual root zone creates a hybrid system, utilizing hydroponics in the upper zone and aquaponics in the lower zone. This design allows nutrient additives to be input into the upper root zone via a nutrient injection system into a separate Nutrient Feed Tank. The user has the flexibility with the PABS to isolate or mix the fish water and nutrient feed using valve controls. When a dual root-zone is being used, a medium with a greater nutrient and water retention capacity is used in the upper zone along with a semipermeable membrane separating the upper and lower zones, which allows roots to grow through into the lower zone while helping to retain the upper zone feed. The aquaponic lower zone water line is maintained about an inch below the zone barrier membrane, and the upper zone receives a precisely measured amount of feed that will not reach the lower zone.

Normal additives for pure aquaponic systems are limited to fish food, iron, occasionally topping off the water level within the system, and pH buffers, and these can continue to be used in the PABS, in both aquaponic and hybrid modes. Because the system continually recycles the aquaponic water, and the hydroponic upper zone is fed precisely, there is no waste water to be disposed of as with traditional hydroponic systems and no runoff as with traditional agriculture. Aquaponics can be conducted outdoors or indoors, and light may be natural or artificial. However, Aquaponics requires a relatively moderate and constant temperature for the fish, which makes Aquaponics particularly well suited for indoor environments where consistent water and air temperature can be adjusted and maintained. The PABS unit is designed with an indoor controlled environment suitable to both fish and plants to allow year-round growing under virtually any outdoor environmental conditions.

PABS Overview.

The PABS utilizes a tall-model (9.5 ft. high—2.9 m) 20 ft. (6.1 m) long or 40 ft. (12.2 m) long shipping container as its structural basis. The shipping container is then modified and outfitted with all the equipment and systems to enable it to function as a self-contained, self-sustaining, off-grid (self-powered) and sustainable (nonpolluting) growing system suitable for most environments on the planet, regardless of access to water or power infrastructure. Key added subsystems include: (a) Hybrid aquaponic/hydroponic multi-grow bed growing system; (b) Recirculating Water System; (c) Plant Feed Control System; (d) Multi-mode Lighting System; (e) Environmental Control System; (f) Electric Power System; (g) Photo Voltaic Array Racking System; (h) Computer Control System; (i) Sensor System; and (j) Security System.

The PABS is designed to provide the following features: (1) maximizes the growing space within the container and the variety of crops that may be successfully grown in the unit; (2) grid/hybrid solar photovoltaic (PV) power generation (designed to be powered off the grid though readily capable of being connected to the grid if needed), wind power generation and energy storage system; (3) redundant backup power generation; (4) water generation, capture, filtration and storage; (5) ability to remotely monitor and control the entire PABS; (6) artificial lighting consisting of multiple spectral LED's (Light Emitting Diodes) specifically designed for horticulture; (7) AC/DC energy management load center and energy hub for multiple power source inputs; (8) dual root zone media beds with three operating modes (aquaponic, hydroponic or hybrid aquaponic/hydroponic); (8) atmospheric water generation; (9) wind turbine power generation; (10) human-powered cycle power generation, (11) energy storage capacity for several operating days without recharging; and (12) a computer hardware and software solution that controls all the subsystems within the PABS. These key systems and features are integrated to create a fully portable, self-contained, self-sustaining and sustainable system that is capable of being deployed in rural, desert, urban and suburban environments without any required access to grid infrastructure such as water or power (our definition of “off-grid”); places where agriculture and/or power and water access would otherwise be difficult or impossible or inaccessible. The PABS is designed to have minimal air leakage which provides superior control over the internal growing environment while minimizing energy consumption. The PABS manages all necessary ecosystem variables using a remotely controllable computer and application software and multiple environmental and system parameter sensors. These subsystems will now be described in greater detail.

Overall Structure:

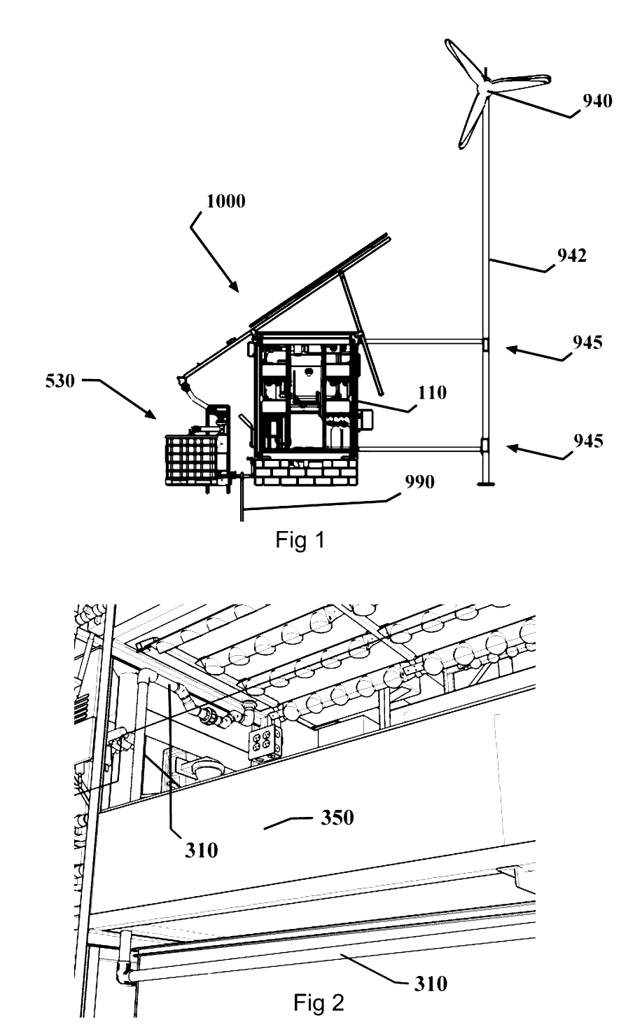

Using a recycled (of course, new containers may also be used) common steel intermodal shipping container as our platform, we have developed a highly portable system capable of growing a wide variety of species of plants/crops, fish and other aquaculture suitable for human consumption. The dimensions of the container used in this design are: Exterior: 20 ft. (6.1 m) long, 9.5 ft. (2.9 m) high, and 8 ft. (2.4 m) wide and are easily adaptable to larger containers, such as 40 ft. (12.2 m) or 50 ft. (15.2 m) in length, which may be divided in the interior into two or more compartments. Interior dimensions may vary slightly per individual containers. The walls normally are corrugated steel panels which also offer channels for wiring used in the invention/designs. Other dimensions are possible and are readily adaptable to the present invention. We have made a number of necessary modifications to the container, including: changing the door locking system, installing a floor drain, and cutting openings in the walls and ceilings for various fittings as described further below. Alternatively, containers of other sizes can be utilized and the systems adapted to fit within them. FIG. 1 shows a full view of the structure from the entrance. The drawing shows the PV (photovoltaic) Array Assembly 1000, the External Water Storage System 530, the grounding electrode 990, the Wind Turbine Bracing Assembly 945, the Wind Turbine Mounting Pole 942, the Wind Turbine 940, and the shipping container 110.

Modifications to Shipping Container:

We modify the standard shipping container (POD) in a number of respects:
1. Install air-tight water drain in floor;
2. Seal all air holes/cracks;
3. Modify door with electric door locks and internal push bar to open;
4. Fully insulate inside and paint with insulating/reflective paint on the exterior;
5. Install custom watertight external ports for power and communications connections;
6. Install Added structural reinforcements;
7. Install an Energy Recovery Ventilation (ERV) system;
8. Install customized built in grow bed frame system;
9. Install customized wiring and electrical systems;
10. Install customized built in heating, ventilation and air conditioning (HVAC) system;
11. Install customized air circulation system;
12. Install customized fish tank;
13. Install mounting pockets and brackets to exterior of the shipping container which will permit secured mounting of equipment to the exterior of the Container;
14. Install connectivity ports on multiple sides of the container;
15. Raised off the ground and leveled using standard custom legs (third-party product made for shipping containers), cinder blocks or similar support structure. This provides space under the container for storage of equipment, tools, storage of fuel tanks for generator, storage of media and other supplies, and vermiculture (worm buckets for procreating worms); and
16. Install ports and mounting pockets/brackets for security system components such as cameras and sensors to be installed on-site during the set-up process.

Grow Beds:

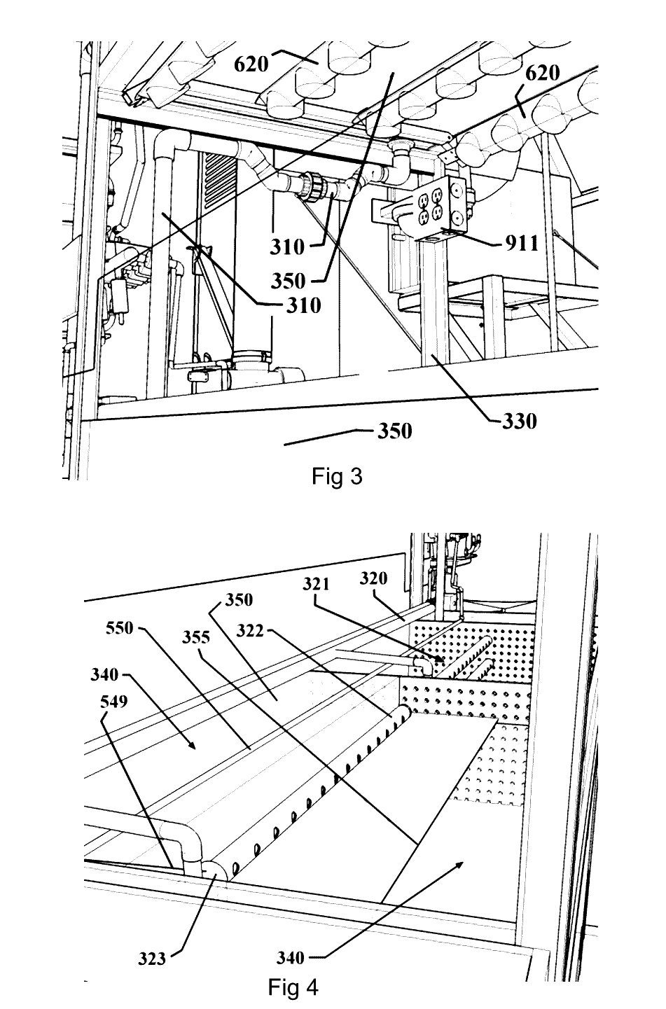

The PABS uses a custom-designed grow bed made from any of several environmentally friendly watertight materials, including Plexiglas, glass, high-density polyethylene, lined wood frame or composite materials which are non-toxic to fish and plants. The beds are held in a metal frame and stacked two high within the PABS container. This multiple grow bed system maximizes the grow space inside the container environment while ensuring efficient and regular circulation of the water within precisely measured parameters. On each side of the container are four grow beds, two on the bottom and two more raised above the two bottom beds. The grow beds contain several ½ in. (1.3 cm) vertical dividers with holes in them that are used to separate the media into sections and for structural support. Each of eight grow beds is 8 ft.×2 ft. (2.43 m×0.61 m) in growing area, for a total of 128 square feet (11.89 m²) of growing area. FIG. 2 shows a close up of the grow beds 350 with a focus on the drain area and piping 310. FIG. 3 shows the grow bed 350, the fill pipe 320, bed frame 330 and drain plumbing 310. Also shown is an electric outlet 911, part of the electrical distribution system, and the LED lights 620. Grow beds are custom-manufactured to specific design and performance specifications, using ½ in. (1.27 cm) Plexiglas or similar material (nontoxic to plants and fish). Grow bed plumbing/piping system uses a customized, gravity operated auto-siphon design. Each bed is filled and drained in a sequence relative to the others using a motorized valve, operated by the computer (PC). The timing is adjusted to maximize aerobic cycling.

Multiple Configurations.

The PABS grow beds can be configured by the user to be either single bed (lower bed only) or double bed (lower and upper beds). Each bedframe section can be configured separately, so it is possible to have single beds in some locations and double beds in others.
1. Configuration A (Two levels). PABS configuration A maximizes yield for crops between 6 in (15.2 cm) and 19 in. (48.3 cm) in height. This configuration has two levels of grow beds, upper and lower. Suitable for Configuration A:

| Suitable Plant Commodities | Suitable Aquatic Commodities |
|---|---|
| Lettuce | Tilapia |
| Tomato | Bass |
| Spinach | Salmon |
| Cauliflower | Shrimp |
| Herbs | COD |
| Broccoli | Lobster |
| Strawberries | Trout |
| Chard | Other crustaceans |
| Kale | And more |
| And much more | |

2. Configuration B (One level). PABS configuration B maximizes yield for crops between 20 in. (50.8 cm) to 55 in. (127 cm) in height. This configuration has the lower grow bed only. Suitable for Configuration B:

| Suitable Plant Commodities | Suitable Aquatic Commodities |
|---|---|
| Corn | Tilapia |
| Wheat | Bass |
| Roses | Salmon |
| Orchids | Shrimp |
| Cannabis | COD |
| Sunflowers | Lobster |
| Beans | Trout |
| Tomatoes | Other crustaceans |
| Daffodils | And more |
| Tulips | |
| Lilies | |
| And much more | |

Single V. Dual Root Zone Bed.

The PABS unit allows growers to choose between running a pure aquaponic system, a pure hydroponic system, or a hybrid aquaponic/hydroponic system. When run as a hybrid aquaponic/hydroponic system, the selected medium/media is added to the bottom of the grow bed 350 and filled to about ⅔ the height of the grow bed (about 8 in. or 20.3 cm). Then, a thin semipermeable membrane (e.g. burlap, hemp, etc.) is laid over the lower zone media to divide the upper and lower root zones (but allows the tap roots to grow down and through the membrane from the upper into the lower zone). The top zone media is then added on top of the membrane to about 1 in. (2.5 cm) below the top of the grow bed. Then, the drip line from the nutrient feed tank is laid across the top of the media and staked in place. Because it is semipermeable to allow the roots to grow through it, the zone barrier membrane itself cannot fully prevent zone leakage (zone leakage is when nutrient-infused water from the upper zone leaks into the lower zone). Preventing zone leakage is achieved primarily not by the membrane but by a) filling the lower zone from below (through the tri-level Dispersion Assembly but using only the lower two pipes) and limiting how high the fish water in the lower zone gets to avoid reaching the upper zone, b) feeding the upper zone via a drip line and not via flood-and-drain, to more accurately deliver just the right amount of nutrient-infused water (from the nutrient feed tank) to the upper zone for the plants' needs without zone leakage; and c) using a medium/media in the upper zone that has a high capacity for water and nutrient retention and even distribution. The combination of these three conditions is what keeps the zone fluids separated and prevents zone leakage. The water levels must be accurate to maintain the zone separation as described, and therefore these are computer 810 controlled. FIG. 4 highlights the dual root zone in a close-up view of a grow bed 350. The drawing shows the zone barrier membrane 355 and dispersion pipe assembly 321, the fill pipe 320, the dispersion pipe 322, the nutrient drip line 550, the computer-controlled flow valve 323, the control wire 549 and the grow bed media 340. The lower media zone covers the bottom two dispersion pipes, while the upper media zone covers the top dispersion pipe, and the two zones are separated by the barrier membrane 355.

The computer software provides an option to operate any of the eight grow beds in pure aquaponic mode, pure hydroponic mode or hybrid aquaponic/hydroponic mode. For those beds operating in hybrid mode, the user inputs the actual depth of each media zone and the fish-water fill amount is automatically adjusted for the lower zone. The computer recommends the amount of nutrient feed to be provided to the top zone, but the user can accept or override this number. The nutrient feed is delivered to the upper zone via the drip lines run from the Nutrient Feed Tank, which have an inline sensor that tells the computer how much feed has been delivered. Only those grow beds the user selected for hybrid operation will receive upper zone feeding. When the feed amount is reached, the computer-controlled valve that connects the Nutrient Feed Tank to the drip line shuts off. The user may experiment with his selected crop and medium/media and root zone combination to determine the optimal amount of feed to apply to the upper zone so as to provide sufficient nutrients without any zone leakage. The feed setting preferences of the user are learned by the computer software and incorporated into future feed recommendations. Sensors to detect levels of all critical parameters are located in both upper and lower zones of the grow beds to provide detailed feedback to the grower about the status of each zone.

Auto-Siphon:

The PABS uses a Flood-and-Drain design of the media grow beds, which when draining, pulls air (ambient air inside the PABS) inside the grow media supplying oxygen to the plant roots. The custom-designed grow beds utilize a custom-built auto-siphon system that facilitates the draining by gravity flow of the grow beds and recycles water back to the fish tank, thereby obviating a pump for that purpose.

Custom Piping:

A custom High Density Polyethylene (HDPE) is commercially available, PVC or similar piping and connector system (that is environmentally friendly and non-toxic to fish and plants) that connects the grow beds, auto-siphons, pumps and the fish tank. The drain piping is pitched at an angle to ensure water drains into the fish tank by gravity.

Dispersion Pipe Assembly:

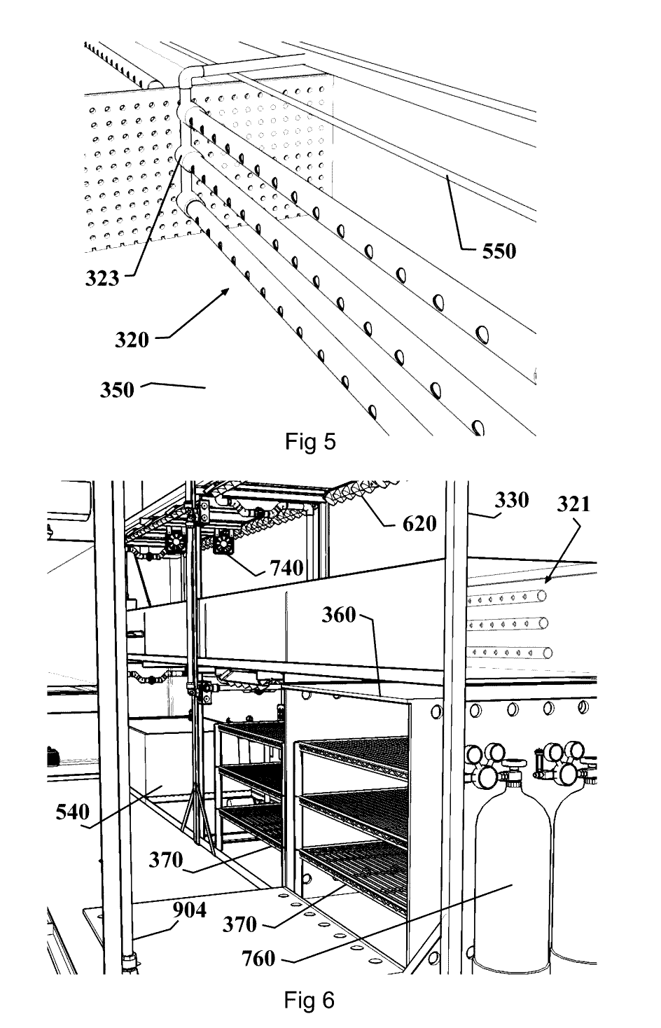

The horizontal piping runs of the fish water end at the grow beds and have an extension down at a 90° angle into each grow bed, referred to as the Drop Pipe. Extending horizontally from the Drop Pipe are three Dispersion Pipes, the first at 2 in. (5.1 cm) from the bottom of the grow bed, the second at 6 in. (15.2 cm) from the bottom of the grow bed, and the third at 10 in. (25.4 cm) from the bottom of the grow bed. Each Dispersion Pipe is connected to the Drop Pipe via a coupling and a computer-controlled flow valve. This configuration allows the grower to choose to fill the grow bed from the bottom, the middle or the top, or combinations of the three, and provides maximum control and flexibility for both mono and dual root zone operation. The Dispersion Pipe is a tube (PVC or similar material) that runs the length of each section of grow bed, is capped on the end and has multiple holes along it and at different positions around its circumference to allow the fish water to be evenly dispersed throughout the grow bed. FIG. 5 shows the Dispersion Pipe Assembly 321 that goes in each grow bed showing the fill pipe 320, the dispersion pipe 322, the nutrient drip line 550 and the computer-controlled flow valve 323. The three-tiered fish-water Dispersion Pipe Assembly 321 allows extreme user flexibility to fill the grow beds from bottom, middle, top or combinations thereof (this increases the probability of even distribution of the bacteria colonies within the media, as opposed to having only one single fill point used in other inventions).

Bed Frame:

The beds are mounted and secured to a custom designed and built steel frame made of angle iron, welded (and in some locations bolted) together and to the container. The frame holds the grow beds, lights, fans and other equipment and supports the internal arrangement of all the equipment within the PABS. The upper grow beds can be removed if the grower wants to increase vertical grow space to 55″.

Incubation Area:

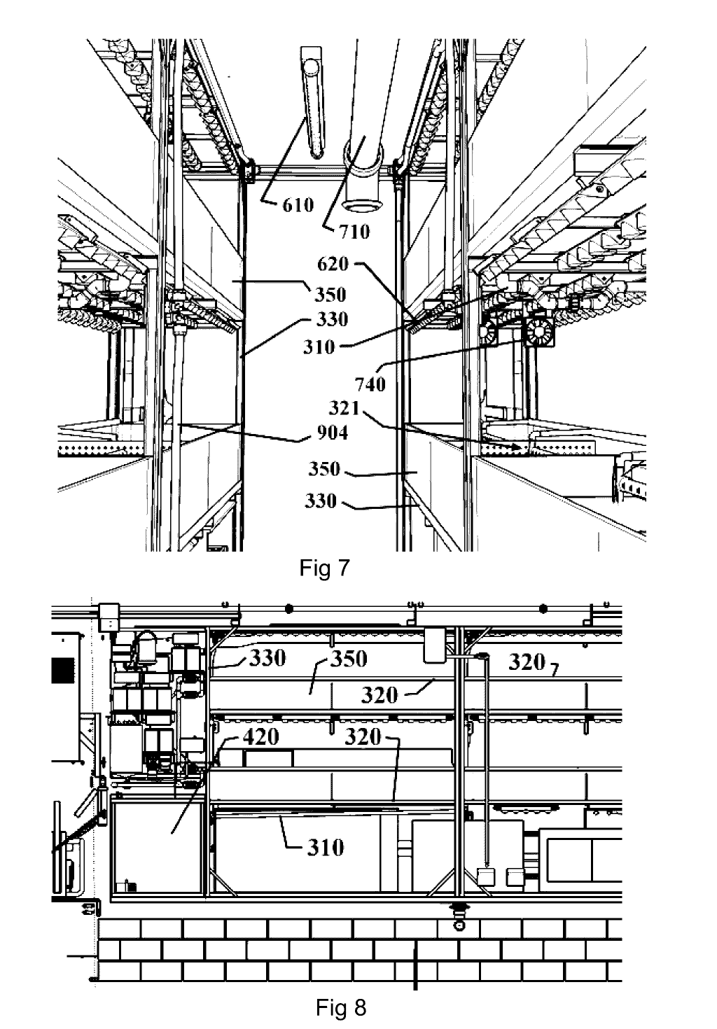

The PABS includes a germination cabinet and an incubation rack under the right hand lower grow bed with a dedicated LED grow lighting fixture in each. The germination cabinet is enclosed to retain moisture within the cabinet and features an opaque front access door and a separate incubation rack is open to the ambient room air within the PABS. FIG. 6 shows an illustration of the germination cabinet and incubation rack including the CO₂ tanks and regulators 760, the incubation racks 370, the germination chamber 360, the internal auxiliary water storage tank 540, the circulation fans 740, the LED grow lights 620, the bed frame 330 and the dispersion pipe assembly 321. FIG. 7 shows the bedframe 330, the grow bed 350, the electrical conduit system 904, the dispersion pipe assembly 321, the circulation fans 740, the grow bed drain plumbing 310, the LED grow lights 620, the ventilation ducting 710 and the interior utility lighting fixture 610.

Fish Tank:

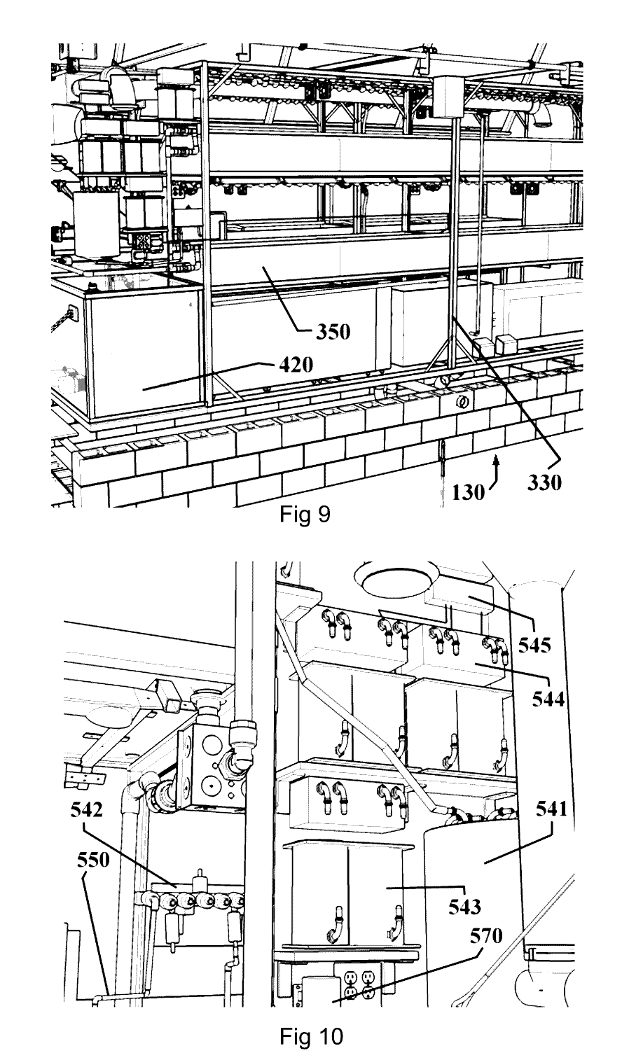

The PABS uses a custom-designed and manufactured ¾ in. (1.90 cm) Plexiglas fish tank (or similar plastic that is environmentally friendly and non-toxic in which to grow fish), built to our specifications, but other materials which are nontoxic may also be used. The size of the fish tank is specifically designed to accommodate the volume of water required for the size of our grow system. FIG. 8 reveals the interior components including Fish Tank 420, the grow beds 350, the bed frame 330, the fill pipe 320 and the drain piping 310. FIG. 9 highlights the Fish Tank 420, the grow beds 350, the foundation 130 and the bed frame 330.

Nutrient Feed Tank:

When operating any grow bed in hybrid mode, the Nutrient Feed Tank is used to mix nutrients into a solution prior to delivery to the grow beds. The PABS utilizes a 25-gallon (94.6 l) tank that draws water from the interior reserve tank. A Nutrient Injection System, controlled by the computer, precisely adds the desired amount of each nutrient to the Nutrient Feed Tank. An air stone in the Nutrient Feed Tank continually mixes the water and nutrients to create the feed solution. Leaving the feed tank, the feed solution exits through an output line and passes through a fluid sensor which measures how much feed has been dispensed. After the sensor, the solution reaches a manifold with eight computer-controlled flow valves, with each flow valve leading to a drip line that runs to its corresponding grow bed. The Nutrient Feed Tank is securely mounted to the interior wall above the fish tank near the ceiling. A pump delivers the water up to the Nutrient Feed Tank and another pump pumps the Nutrient Feed Tank Solution to the grow beds via the Nutrient Drip Line. FIG. 10 shows the Nutrient Injection System, including the Feed Manifold 542, the nutrient drip line 550, the nutrient feed pump 570, the nutrient reservoirs 543, the nutrient feed tank 541, the Nutrient dosing controller 544 and the nutrient dosing base unit 545.

Nutrient Injection System:

when operating any grow bed in hybrid mode, the Nutrient Injection System maintains a reservoir for each of the required nutrient concentrate solutions (N, P, and K, etc.) and a computer controller dispenses each nutrient into the Nutrient Feed Tank. The third-party Nutrient Injection System being used for this design has multiple options for monitoring and control of: automatic nutrient feeding, PAR, leak detection, LED and pump control, pH/oxidation reduction potential (ORP), Salinity, dissolved oxygen. This system can be activated and controlled by the PABS computer control system.

Water Pumps:

The PABS contains a number of third-party water pumps located throughout the water and feed systems, as detailed throughout this document and illustrations, specifically: 1) to move fish water from the fish tank to the grow beds; 2) to move clean water from the auxiliary water tank to the Nutrient Feed Tank; 3) to move feed solution from the Nutrient Feed Tank to the Grow beds; 4) A backup pump is installed in case of the event that the primary water pump malfunctions. 5) to move water from the rainwater storage system through a water filter, to the auxiliary water tank. 6) to move water from the auxiliary water tank to the fish tank. 7) to move water from the dehumidifier to the auxiliary water tank. Gravity moves the water from the grow beds back into the fish tank.

Atmospheric Water Generator:

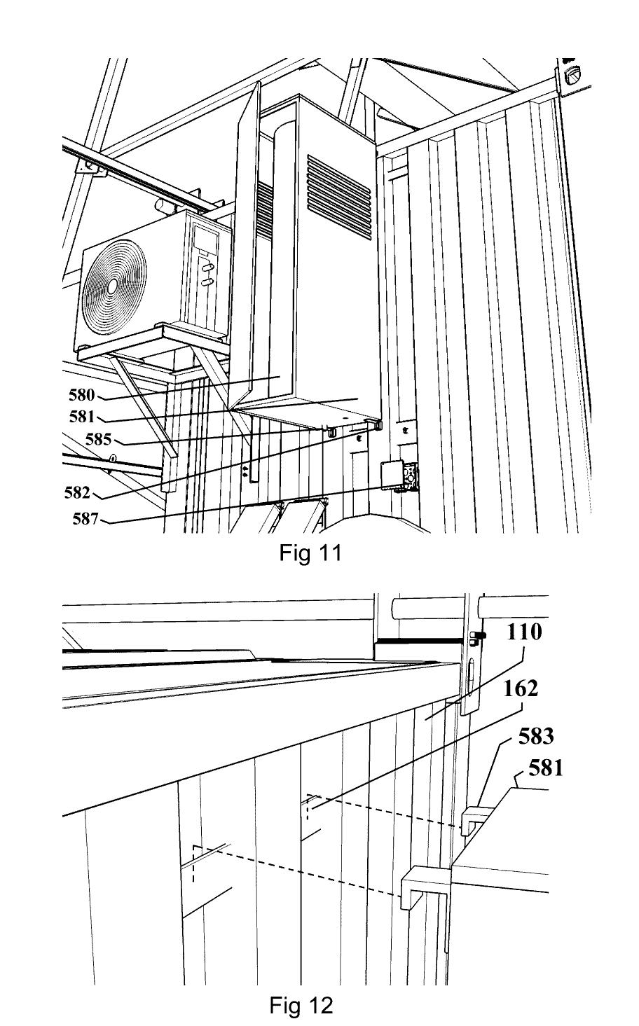

The PABS unit comes equipped with a third-party Atmospheric Water Generator (AWG). The model we have selected for this system is 48″ high×13′″ wide and 20″ deep (121.9 cm×33 cm×50.8 cm), generates up to 8 gallons (30.3 l) of water per day and requires 700 W per hour of operation. As part of the on-site setup process, the AWG is mounted to the exterior of the PABS container inside a metal security enclosure and a water line run down to the auxiliary water tank input. The AWG receives power from the AC distribution panel. FIG. 11 shows the AWG with power connection and water output fitting. Identified in this figure are the AWG enclosure 581, the water output fitting 585, the Welded Mounting Arm 582 for the AWG enclosure 581 and the junction box 587 for wiring the AWG in to the system. FIG. 12 is a close up illustration of the exterior of the shipping container 110 showing how the AWG enclosure 581 mounts onto the shipping container 110 by hooking the Welded Mounting Hooks 583 onto the enclosure to the Welded Mounting Brace. FIG. 36 further illustrates how the bottom of the AWG enclosure 581 mounts onto the shipping container by hooking the Welded Mounting Arms 582 onto the enclosure to the Lower Welded Mounting Brace with locking brace 160 on the shipping container 110. Also shown in this drawing are the water output 585 from the AWG, the power input to the AWG 586, the junction box 587 to wire the AWG to the system, and the generator inlets 935.

Exterior Water Storage System Water Filtration.

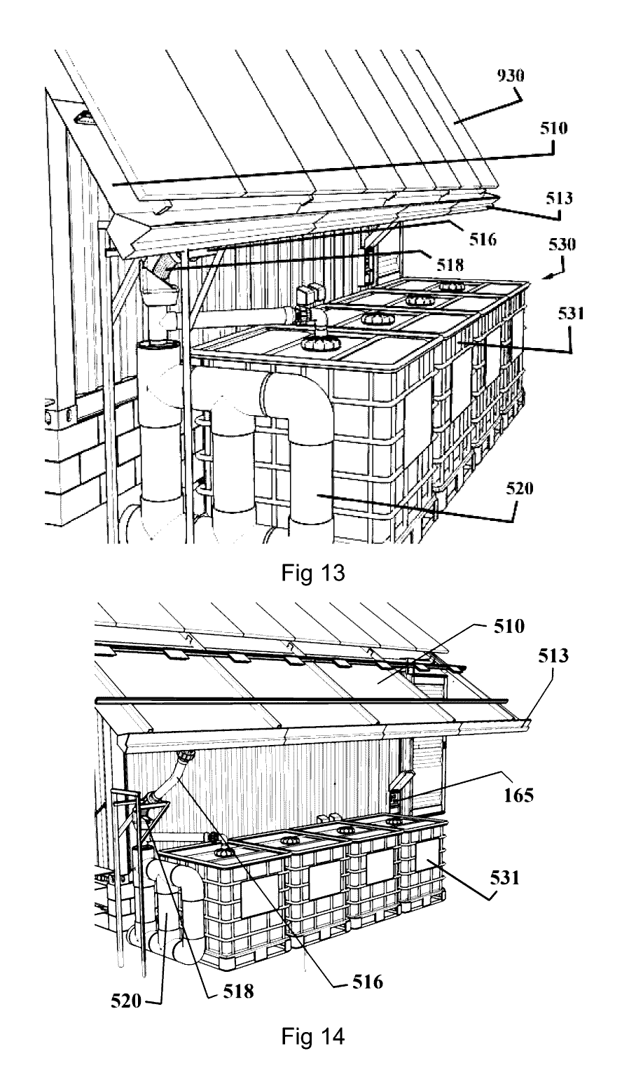

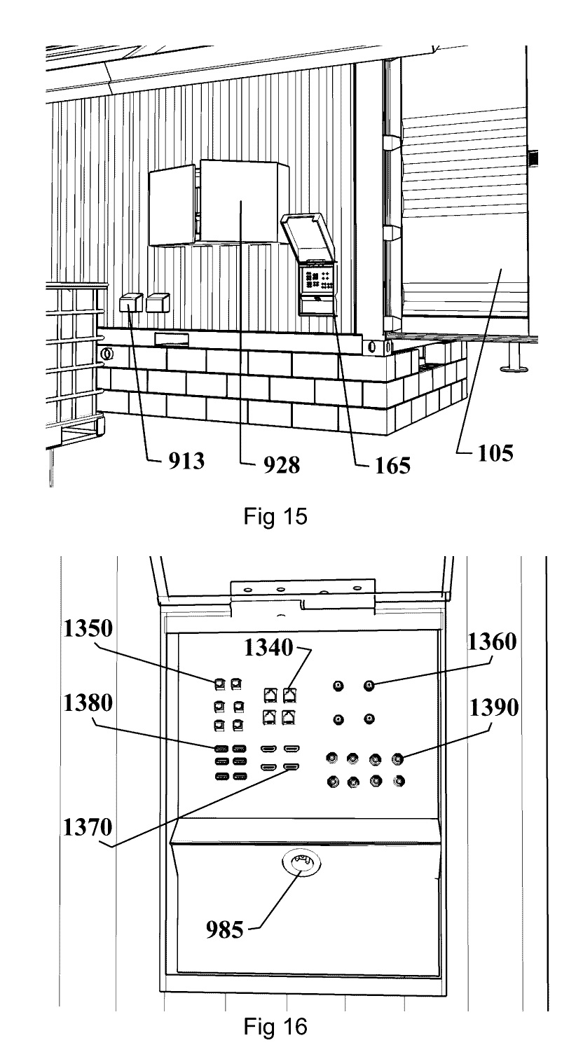

Incoming rainwater collected from the solar PV panel catchment array passes through a dual-stage cleaning system before collecting in the IBC tote assembly. The first stage of rainwater cleaning is a leaf-guard filtration that prevents large debris from entering the water system. The debris filter is attached to the top of the EWSS intake located above the First Flush Diverter unit. The second stage of rainwater cleaning is called a First Flush Diverter, and is a custom-designed water processor constructed of PVC or HDPE piping segments The first flush of water from the solar PV array water catchment system can contain amounts of bacteria from decomposed insects, lizards, bird and animal droppings and concentrated tannic acid. It may also contain sediments, water borne heavy metals and chemical residues, all of which are undesirable elements to have in the PABS' water system. Rainwater runoff from the adjustable PV Array is directed to one end of the unit where it drains to the storage tanks through a flexible and expandable 3 in. (7.6 cm) diameter hose. This hose is provided with customized extensions designed to fit three seasonal Array angles. The operator simply attaches or removes the extensions at the time the seasonal adjustments are made. The First Flush Diverter is attached to the side of the IBC Tote assembly and receives water from the rain gutter after passing through the first debris filter. After the First Flush Diverter is full of the flush water, a floating ball inside the fill chamber rises and blocks the fill hole to the fill chamber, thereby rerouting subsequent clean water to flow directly to the IBC tote storage tank assembly. A user-adjustable slow relief valve at the bottom of the Flush Filter allows the flush water to drain over time based on the tightness of the relief valve. FIG. 13 shows an isolated illustration of the Exterior Water Storage System and water filtration including the IBC tote storage assembly, the First Flush Diverter and the debris filter. Shown in this drawing are the Solar PV Modules 930, the Rainwater Collection Pan 510, the Rain Gutter 513, the 3″ flexible hose 516, the Leaf Guard Filter 518, the First Flush Diverter 520 and the External Water Storage System 530, consisting of four modified IBC totes 531. FIG. 14 provides additional details of the water system 500 including the Rainwater Collection Pan 510, the Rain Gutter 513, the Leaf Guard filter 518, the 3 in. (7.6 cm) diameter flexible hose 516 and the IBC totes 531. Also shown is the multifunction port hatch 165. (Note: to make viewing the Rainwater Collection Pan easier, the bottom row of Solar PV Modules has been removed in this and other related drawings). FIG. 15 shows the exterior corner of the system with the shipping container door 105, the multifunction port hatch 165, the energy management center 928 and two external GFCI outlets with in-use covers. FIG. 16 is a close-up illustration of the multifunction port hatch 165 showing CATS connectors 1340, telephone connectors 1350, RF connectors 1360, RCA connectors 1390, HDMI connectors 1370, USB connectors 1380 and a grid connection inlet 985.

Customized Auxiliary Water Tank and Automatic Refill Backup System:

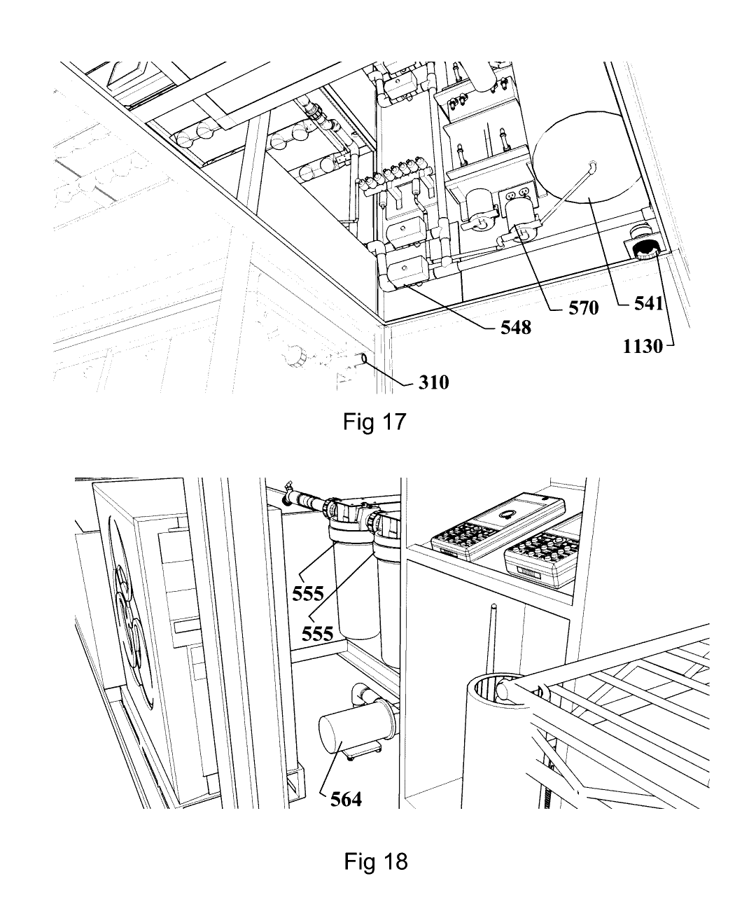

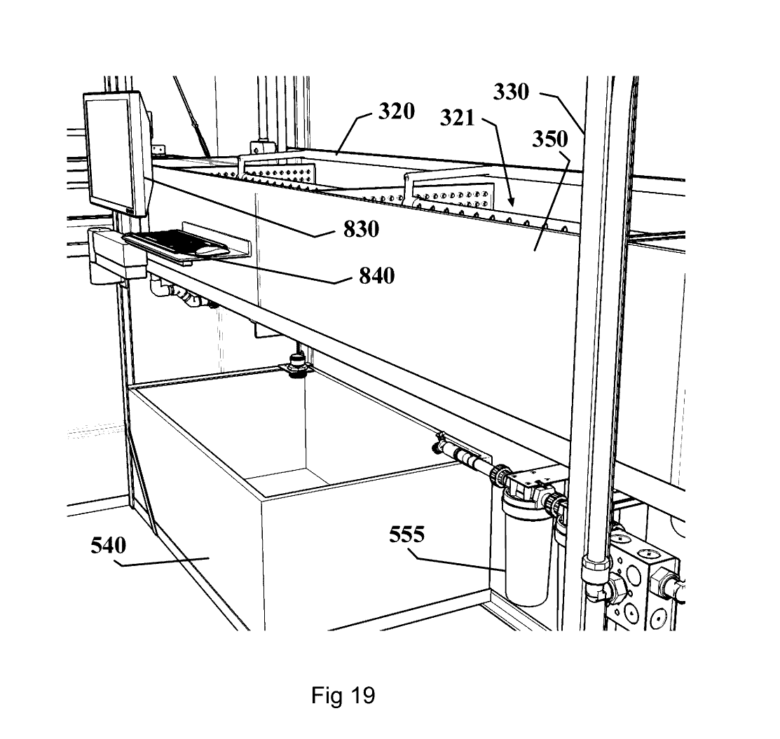

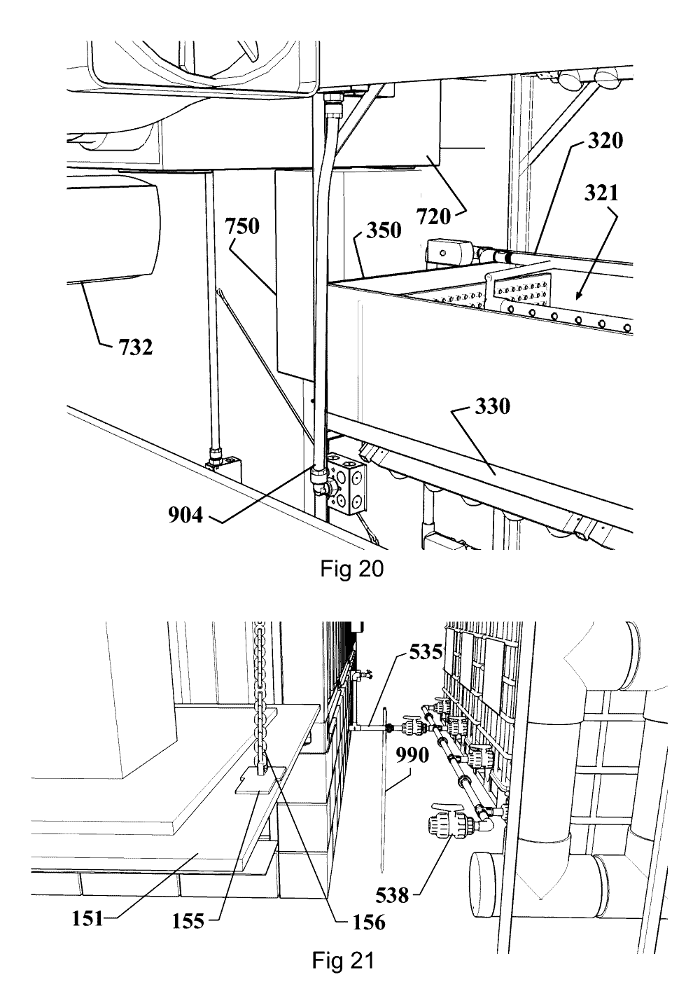

The PABS includes a 60-gallon (227.1 l) auxiliary water tank for extra onsite water storage. This tank is located inside the unit under the lower grow bed on one side of the unit. The water in this auxiliary tank is fine filtered and temperature controlled by the ambient air temperature inside the PABS unit, so that it can be pumped into the fish tank at any time to ensure the water level in the fish tank remains within specified required parameters. The fish tank is fitted with optical and/or ultrasonic water depth sensors. In the event that the water level in the fish tank drops below a certain level (e.g., 10% below full), the system will automatically refill the fish tank with water from the auxiliary storage tank. The auxiliary tank is fitted with an optical and/or ultrasonic water depth meter and an automatic fill valve, to maintain the depth at one foot. Two optical and/or ultrasonic water level sensors are included in the event that one malfunctions. The PABS automatic refill functionality facilitated by the interior auxiliary water storage tank also ensures that water refilled into the fish tank is the same temperature while at the same time automating what is otherwise a user-required activity of topping off the fish tank on a daily basis. FIG. 17 shows interior detail viewed from a point within the fish tank to show the drain pipe 310, the computer controlled flow valve 548, the pumps 570 for the nutrient drip line, the Nutrient Feed Tank 541 and the Fish Tank Water Level Sensor 1130. FIG. 18 shows the water pump 564 and water filters 555 located inside the container 110 under the grow bed next to the communications center. Also identified in this drawing is the PC tower 810 which is raised off the floor on a 2 in (5.1 cm) platform. FIG. 19 shows the customized 60-gallon (227.1 l) auxiliary water tank 540 including the water filters 555 located inside the container 110 under the grow bed 350. Also shown are the bed frame 330, the dispersion pipe assembly 321, the fill pipe 320, the computer monitor 830 and keyboard 840. The PC tower 810 is not shown in this figure. FIG. 20 shows another view of the interior. Identified in are the bed frame 330, the grow bed 350, the Energy Recovery Ventilator 720, the dispersion pipe assembly 321, the fill pipe 320, the dehumidifier 750, the interior section of the HVAC Mini-split 732 and the electrical distribution conduit 904.

Water Spigot and Water Filter:

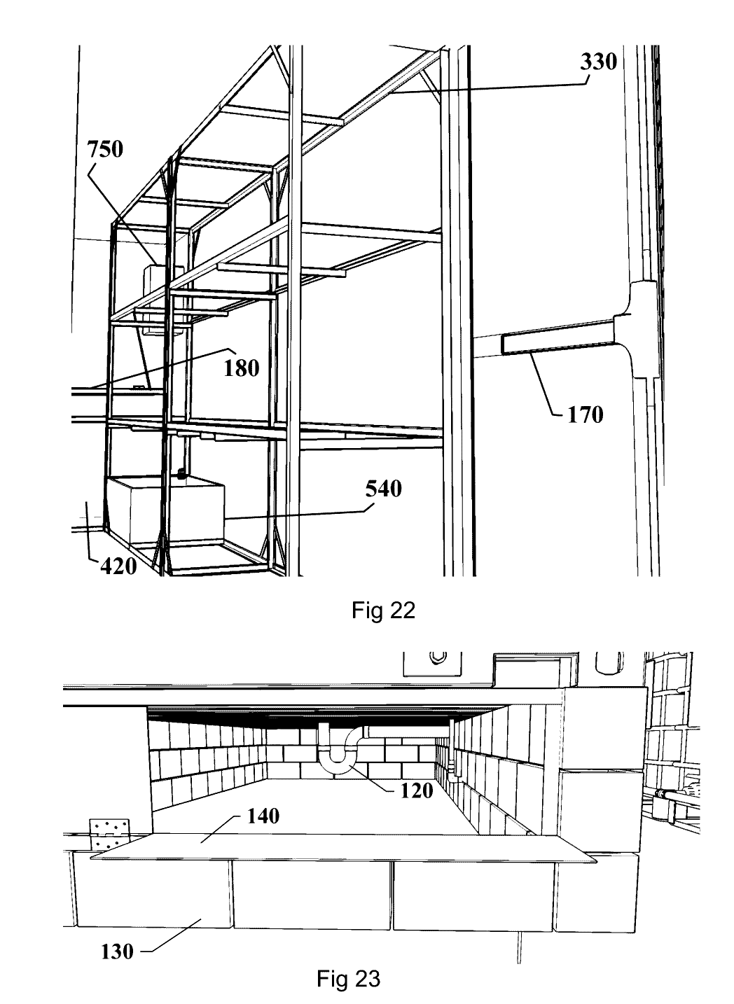

The PABS includes a locking water input valve mounted outside and connected to the water filtration system. This allows users to fill or top off the internal 60-gallon auxiliary tank (filtered through the internal water filtration system first) with municipal water via a standard hose, as a back up to the water catchment and atmospheric water generation systems of the PABS unit. FIG. 21 shows the Exterior Water Storage System 530 with the water spigot mounted to the PABS above the Internal Auxiliary Water Storage Input Pipe. Visible in this drawing are the Internal Auxiliary Water Storage input pipe 535, the IBC Tote Water Storage Output Valves 538 and the grounding electrode 990. Also visible in this figure are the generator platform 151, the Welded Mounting Brace with Chain Loop 155 and the Platform Support Chain 156. FIG. 22 shows some of the internal components of the water system 500 including the Fish Tank 420, the Internal Auxiliary Water Storage Tank 540. Also visible in this drawing are the dehumidifier 750 and the door lock push bar 170. The bedframe 330 is visible as a frame of reference for positioning.

Air Pumps:

The fish (and other aquaculture) in the fish tank need to breath oxygen in the form of dissolved oxygen (DO) in the fish water. Oxygen (O₂) is also critical for the health of the roots of the plants, the worms and the bacteria and other microorganisms that need oxygen, so maintaining optimal levels of oxygen in the fish water will promote the optimal health of all the living elements of the PABS. O₂ is added to the fish water when the surface is broken and an exchange of atmospheric oxygen with the water takes place (see “Aquaponic Gardening”, 2013). This design does not typically require an external pump to oxygenate the water because the draining of the water from the grow beds and falling into the fish tank, breaking the plane of the fish water, typically drives adequate oxygen into the fish water. Also, the turbulation of the Flood and Drain fill process, where fish water is dispensed into the grow beds drives dissolved oxygen (DO) into the fish water. However, the unit has a main air pump and a backup air pump for those circumstances where the user requires higher levels of DO in the water. In the event the water pump fails, an air pump also serves as a backup to ensure the fish have adequate oxygen at all times, by pumping the ambient air in the PABS (which contains oxygen) through a tube directly into the bottom of the fish tank connected to an air stone or diffusion device. This sends small bubbles of air through the fish water in the fish tank breaking the surface of the fish water when they float to the top. The Computer Control system (CCS) will switch on the air pump when it detects that the water has less than the minimum threshold amount of DO. This minimum threshold is fully adjustable by the user. The ambient air in the PABS will maintain a minimum level of O₂ (set by user) and draw fresh air through the ERV whenever that minimum is not satisfied, increasing O₂ in the PABS.

Growing Medium:

The PABS comes standard with expanded shale as the growing medium, but other materials such as clay, expanded clay, pumice, river stone, bio-char, synthetic, recycled glass or combinations of media types may be used instead. For dual root zone grow beds, the medium may also include unconsolidated mineral and/or organic material.

Fish/Plant/Crop Ratio:

The size of the fish tank and the size of the grow beds have been scientifically determined to maintain the optimal ratio of fish weight to plants/crops. Fish tank capacity (375 gallons-1041 l) of the current 20 ft. (6.1 m) unit is designed to achieve the optimal ratio of 3.3 gallons (12.5 l) of water per pound (0.45 kg) of fish, for a total capacity of 114 lb. (51.7 kg) of fish. The size of the grow beds is balanced at 1.14 square feet (0.106 m²) per pound (0.45 kg) of fish.

Vermiculture:

A variety of worms are added to the grow beds, where various species of bacteria will be cultivated for converting fish waste into quality nutrients usable by the plants (vermiculture). Worms break down and digest the solid fish waste in the fish water and the dead root matter that plants slough off. The waste from worms is called vermicompost or worm castings, and when steeped in water it becomes a bountiful source of nutrition for plants.

Insulation:

The PABS includes double-insulated (2″ [5.08 cm] insulation panels) walls, floor and ceiling. In addition, special environmentally friendly and non-toxic insulating paint-on coatings applied to the exterior of the PABS container to reduce heat gain.

Custom Floor Drain:

The PABS floor includes a custom-designed drain, made from PVC, HDPE or similar material, which permits water to drain out and allows no air in. The floor is slightly sloped from each corner of the grow bed space toward the center. FIG. 23 shows the floor drain p-trap 120, and the Foundation 130 with Foundation Access Hatch 140.

Air-Flow:

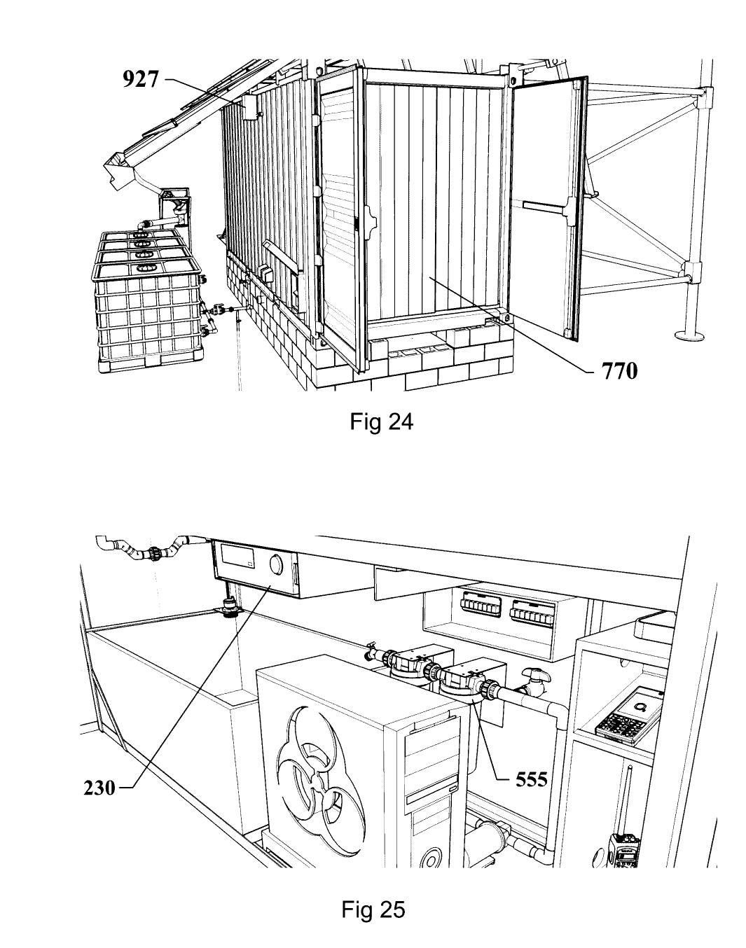

When the PABS door is closed the unit is sealed nearly air-tight unless the unit is set to intentionally draw air through the energy recovery ventilation system or when access is required through the door. The ERV allows a positive, neural or negative pressure differential with respect to the external environment and based on the preferences of the user. For example, a slight positive pressure differential prevents insects from entering the unit through any opening. A plastic door curtain is also installed at the opening of the two doors as an air and thermal barrier to assist in preventing insects from entering the unit and prevent unwanted air exchanges when the doors are open. FIG. 24 shows the plastic door curtain 770 and micro-inverter junction box 927.

Computer Control System (CCS):

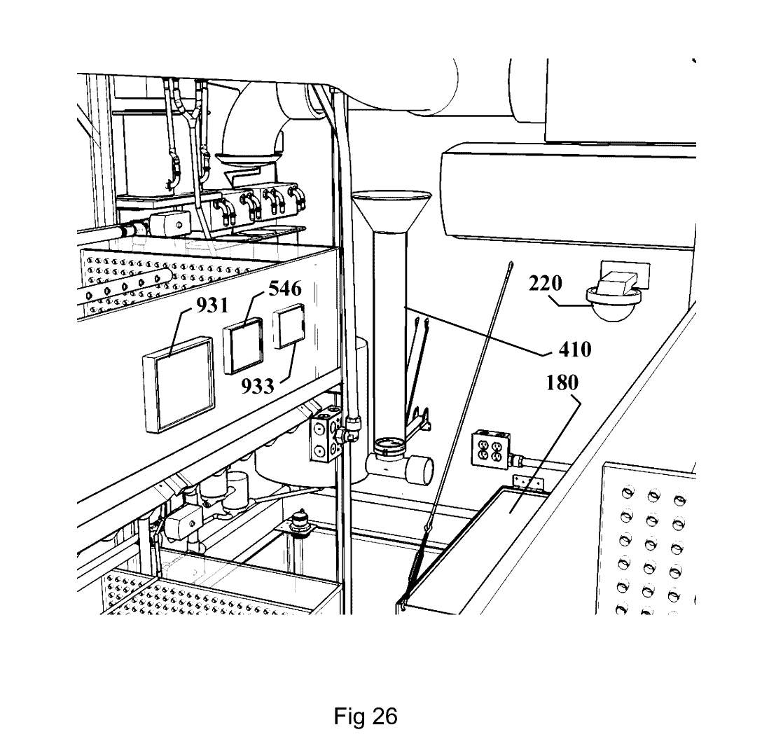

The PABS includes a Computer Control System that integrates all the electronic and physical systems of the PABS to provide a comprehensive and user-friendly interface that allows complete on and off site monitoring and control over virtually every aspect of the PABS. This includes full control over the integrated Microgrid power system (see Microgrid power system below). A personal computer is located inside the PABS) and runs custom-designed software that controls the PABS hardware and manages the operational requirements as well as runs multiple applications to perform specific information functions. Some of the key functions of the Computer Control System include:
1 Energy Management. The CCS monitors energy generation, storage and consumption, weather conditions, plant and fish health, and all system parameters and adjusts the system automatically to ensure optimal conditions are maintained, while notifying the user of any adjustments and the reason(s) such adjustments were made. The user also has the option to override any setting remotely, giving the user unparalleled access, automation, reliability and control. For example, if the weather forecast is for overcast skies and no wind for several days, the system can automatically temporarily reduce lighting intensity, adjust air temperature, or make other system adjustments to conserve power so as to extend the operation of the system without harming the plants or fish or necessitating the deployment of the grid, backup generator or human-powered generator.
2 Environment. The CCS manages all the components and parameters of the environmental controls, including multiple sensors to monitor all critical environmental conditions within the PABS (see below for environmental controls detail);
3 Communications. The CCS manages the PABS' communications capabilities to ensure transmission of critical systems information to users or others (see below for communications equipment specifications.);
4 Crop Data. The CSS connects to a crop management database to provide system crop growing parameters and preferences. The CCS manages crop growth scheduling and tracking, harvest projections and yield/stock inventory. The CCS manages the timing of each crop, can automatically switch growth phases from vegetative to flowering or pre-harvest stages, and modify all system parameters accordingly;
5 Fish Feeding. The CCS manages a user-specified feeding schedule for the fish and also controls the automatic fish feeder to implement the user-specified feeding preferences, and also notifies the user when it is time to add any fish food supplements manually or refill the automatic feeder. Additionally, a sensor will alert the user if the fish feeder is not dispensing properly. This functionality automates what is normally a required daily user activity;
6 System Event Monitoring. The CCS manages an alert system designed to keep users informed in the event of changes in system conditions and any system events, whether they are expected, scheduled or unexpected events;
7 System Data. The PABS sends data to Smarter Planet Enterprises Command Center for analysis of the system's performance;
8 Pump Management. The CCS monitors the performance of all the PABS' water pumps and notifies the user of performance issues and can switch from primary to secondary pumps when it detects a performance issue;
9 Grow bed Management. The CCS controls the grow bed configuration(s), operating mode selections and media zone parameters, flood and drain cycle timing and maintenance options;
10 Nutrient Feeding. The CCS controls the hydroponic nutrient injection, mixing and feeding components based on configuration, crop(s) and operating mode selections made by the user.
11 Dispersion Assembly fill control. The CCS controls the valves which comprise the Dispersion Assembly, allowing the user to modify or maintain the grow bed fill method;
12 Security Systems. The CCS interfaces with the PABS' security systems and allows the user to monitor and control door access, cameras and access security reporting functions. The CCS computer is mounted to the end of the side of the grow bed frame and is connected via a wiring harness to all the electrical components of the PABS. FIG. 25 shows details of the security system including the DVR 230 mounted to the underside of the north grow bed 350. The water filter 555 and the PC tower 810 are also visible in this figure in front of the water filter 555. FIG. 26 presents another view of the interior showing the PV power monitor 931, the Inverter/charger power monitor 933, the Nutrient Injection System display 546 all mounted to the side of the grow bed. A security camera 220 is mounted to the wall above the drop-down workstation 180 next to the automatic fish feeder 410.
13 Communications. The CCS interfaces with the PABS' security system to ensure that system information is communicated to the user as directed.

Environmental Controls:

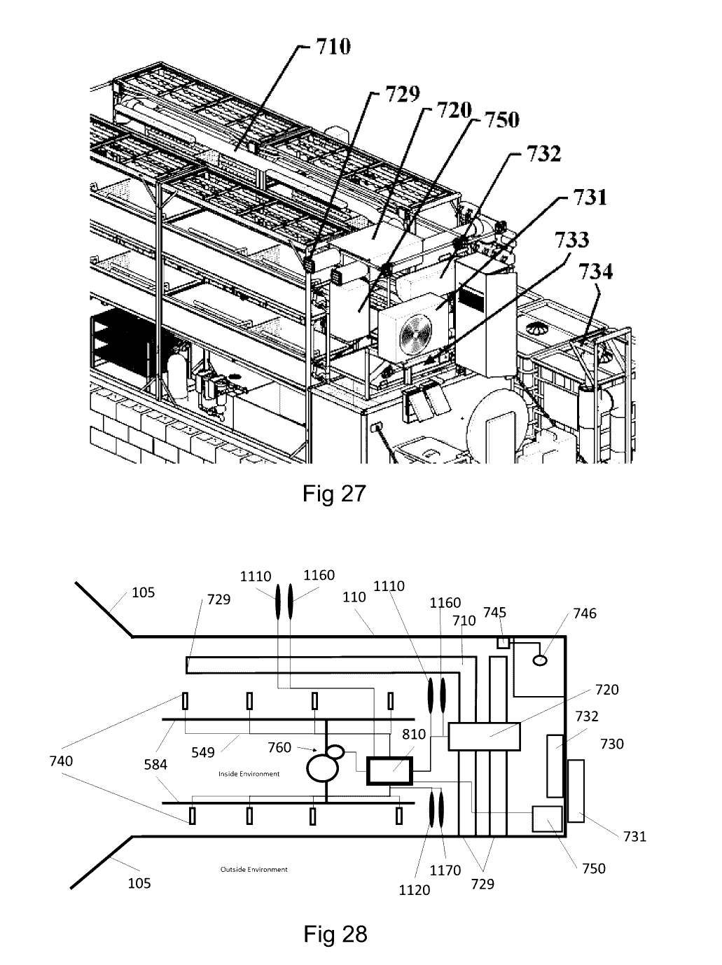

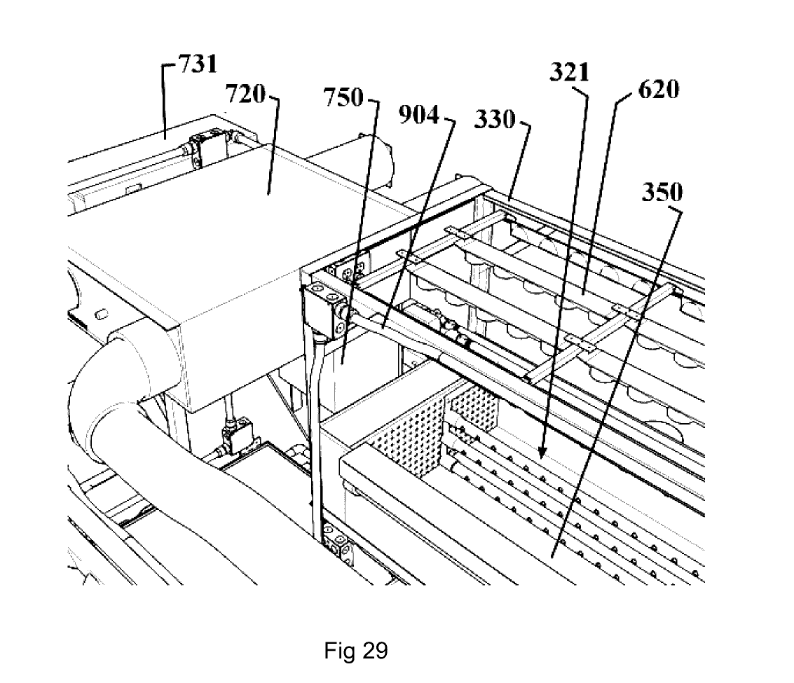

Environmental controls include:
1 Air: Ambient air temperature, humidity, circulation and ventilation. Because the fish tank is housed inside the air environment, the fish tank water temperature is the same as the air temperature in the PABS container and does not need to be separately maintained.
2 HVAC: A heating, ventilation and air conditioning (HVAC) and humidity control system keeps the ambient temperature and humidity inside the PABS at the appropriate levels despite fluctuating outside conditions. FIG. 27 shows the interior and exterior sections of the HVAC system including the ducting 710, the vent cover with louvers 729, the Energy Recovery Ventilator 720, the dehumidifier 750 the interior 731 and exterior 732 sections of the HVAC mini-split, the Mini-split exterior mounting assembly 733 and the steel iron angle segments 734 that support the First Flush Diverter. For this design we have selected a 9000 BTU ductless mini-split heat pump heating and air conditioning unit with a capacity of 494 cubic feet (14 m³) per minute (CFM). When operating, this unit also dehumidifies the air at the rate of 3.2 pints (1.51 l) per hour.
3 Condensation drain tube: The condensation drain tube from the HVAC evaporator coil exits into the internal auxiliary water tank, for the purpose of reusing the condensed water vapor from plant transpiration back into the PABS system to reduce total water loss.
4 Dehumidifier: The PABS comes equipped with a commercial dehumidifier to dehumidify the air when dehumidification but not air conditioning is needed. The model of dehumidifier we have selected for the PABS is 150 cubic feet (4.24 m³) per minute (CFM), requires 115 v at 5.1 amps and removes 70 pints (33.12 l) per day (PPD) of water from the air. The model we have selected is 12 in.×12 in.×21 in. (30.48 cm×30.48 cm×53.34 cm). The PABS should require no more than 40 PPD (18.92 l) of water removed so the dehumidifier is estimated to only run half of the day, at most. The dehumidifier is mounted to the interior wall of the PABS and the drain line from the dehumidifier runs back in to the auxiliary water tank. A pump moves water from the dehumidifier to the auxiliary water tank. Because the air conditioner also dehumidifies, under normal circumstances the dehumidifier will not run simultaneously with the air conditioner. FIG. 28 is a diagrammatic view of the Environmental Control System 700 showing the shipping container doors 105, the air ducting 710, the sensors for temperature 1110, CO₂ 1160, humidity 1120, and O₂ 1170, circulation fans 740, the CO₂ dispersion tubing 58), the control wires 549, the CO₂ tank with regulator 760, the PC (personal computer) 810, the dehumidifier 750, the HVAC Minisplit interior 732 and exterior 731 sections, the Energy Recovery Ventilator 720, the vent covers with louvers 729, the air pump 745 and air stone 746 in the fish tank.
5 Energy Recovery Ventilator (ERV): An energy recovery ventilator (ERV) recaptures the energy typically lost through a structure's ventilation process. It exchanges stale internal air for fresh external air (filtered) while exchanging heat and moisture. The outside air is pretreated in this process to reduce the HVAC system load and overall energy consumption of the PABS. FIG. 29 shows a close-up of the ERV unit with the shipping container removed for clarity to reveal the ERV 720, the dehumidifier 750, the electrical conduit distribution system 904, the bed frame 330, the dispersion pipe assembly 321, the LED grow lights 620 and the grow bed 350. The ERV is programmable to maintain a positive, negative or neutral pressure differential between the inside and outside of the PABS.
6 CO₂: Carbon dioxide (CO₂) production and distribution. The enclosed and controlled growing environment allows supplementation of environmental CO₂ levels for optimal plant growth, as plants convert CO₂ and water (using light as an energy source) into sugar and oxygen via photosynthesis. CO₂ sensors and a control system are installed which will enhance CO₂ levels to user-desired set points, from either a CO₂ gas cylinder or CO₂ gas generator (this embodiment of the PABS uses a gas cylinder so as to not burn conventional fuel in producing CO₂). The Computer Control System can control the CO₂ dispersion based on real-time data from the CO₂ sensors. CO₂ is dispersed to the plants via plastic tubing from the CO₂ regulator run along the top of the grow beds as shown in FIG. 28.
7 O₂ level Air: Air Oxygen (O₂) sensors will provide real-time data to the Computer Control System, which will initiate air exchange of the ERV whenever O₂ levels drop below the user-set minimum level.
8 O₂ level Water: O₂ monitors for the dissolved oxygen (DO) levels in the water will provide real-time data to the CCS, which will turn on the air pump and/or the ERV whenever DO levels drop below the user-set minimum level.
9 Water temperature: The water temperature is dependent on, and will vary only a few degrees from the ambient air temperature inside the PABS, as the PABS is virtually sealed from the outside temperature.
10 Air purification: Air purification system to keep air contaminants out of the PABS: The ERV contains basic MERV (minimum efficiency reporting value) filters. The HVAC also contains air filters. These filters can be replaced when necessary for routine maintenance and can be obtained from multiple sources.
11 Air Circulation system: Custom-designed internal air-circulation system utilizing low-power-consumption fans. This subsystem continually mixes the air within the PABS to maintain a homogenous environment free from microclimates, and ensures balanced CO₂ absorption by the plants.

Multi-Mode Lighting System:

The PABS provides three modes of lighting. 1) Light Emitting Diode (LED) grow lights provide optimal spectra of light to plants and is measured in PAR (photosynthetic active radiation). LED component lights (or custom designed lighting) with optimized spectrum for plant growth and optional diffusion lens covers have been installed. Optional configurations of supplemental lights can increase the amount of light and PAR value available to the plants. 2) White LED ambient light is provided for working in the PABS when it is not operating. 3) Green LED light is provided for working in the PABS when it is operating and in the dark cycle. 4) LED grow lights in the germination cabinet and incubation rack. The PABS unit utilizes dimmable Light Emitting Diode (LED) technology above each grow bed that can virtually alter plants' photosynthesis and/or photomorphogenesis response with up to multiple different spectral and wavelength options, allowing more robust growth in less time. The LED plant growth fixture is designed to produce high photosynthetically active radiation (PAR) values with unsurpassed beam uniformity and excellent light utilization. The PABS LED design consists of each 8 ft. (2.43 m) grow bed with two rows angled inward to maximize PAR over the entire area of the grow bed and canopy with each row consisting of two four foot (1.21 m) light bars. The design of the PABS allows the user to control each row individually. Also, the design of the PABS's grow bed frames allows users to add multiple rows of LED light bars and control each row individually as well, depending on user preferences. The dimensions of each light bar is 2 in. (5.08 cm)×0.86 in. (218.44 cm)×48 in. (121.92 cm). The slim fixture design optimizes the use of vertical stacking of plant grow beds, which results in greater volumetric plant density. Each set of light bars (two light bars per set per row) consumes approximately 150 W.

Custom Integrated/Microgrid Power System:

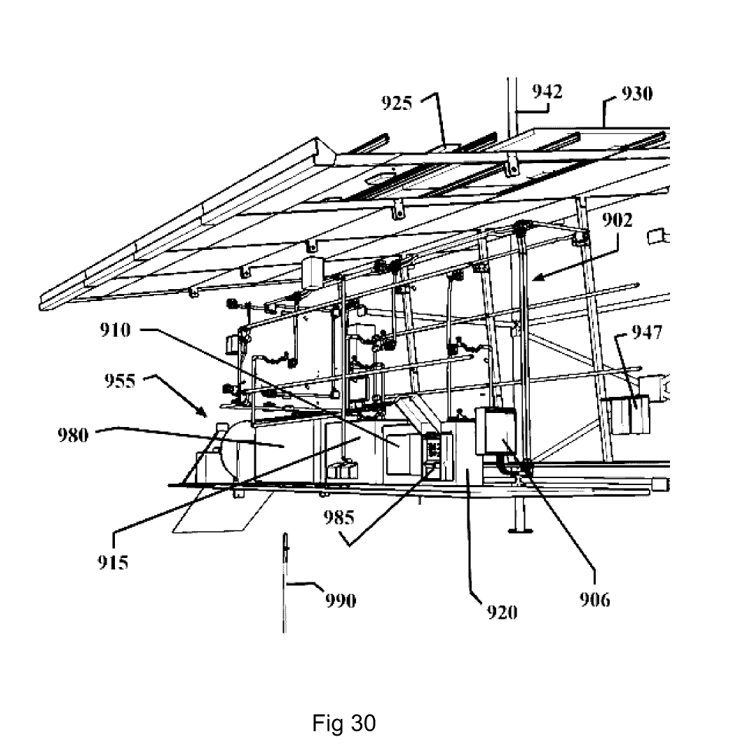

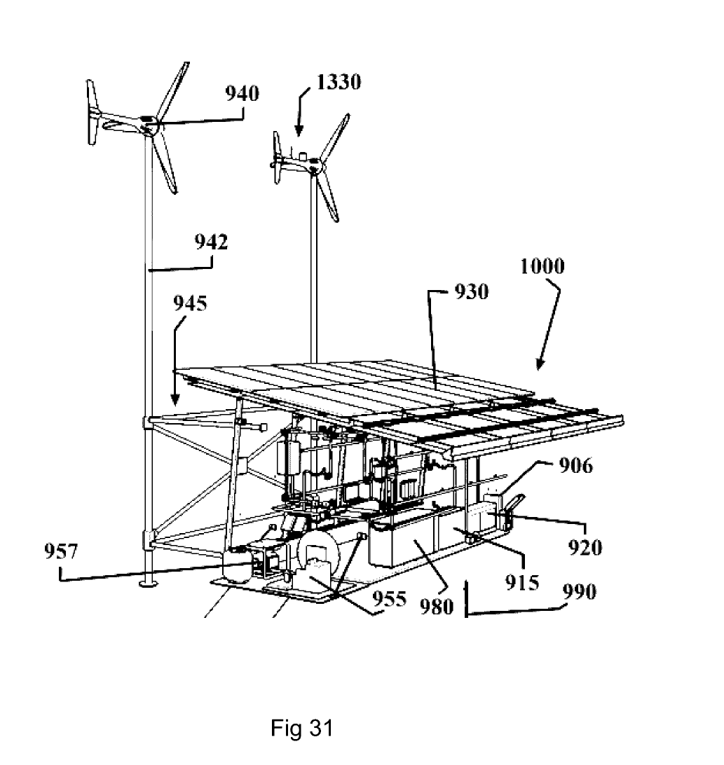

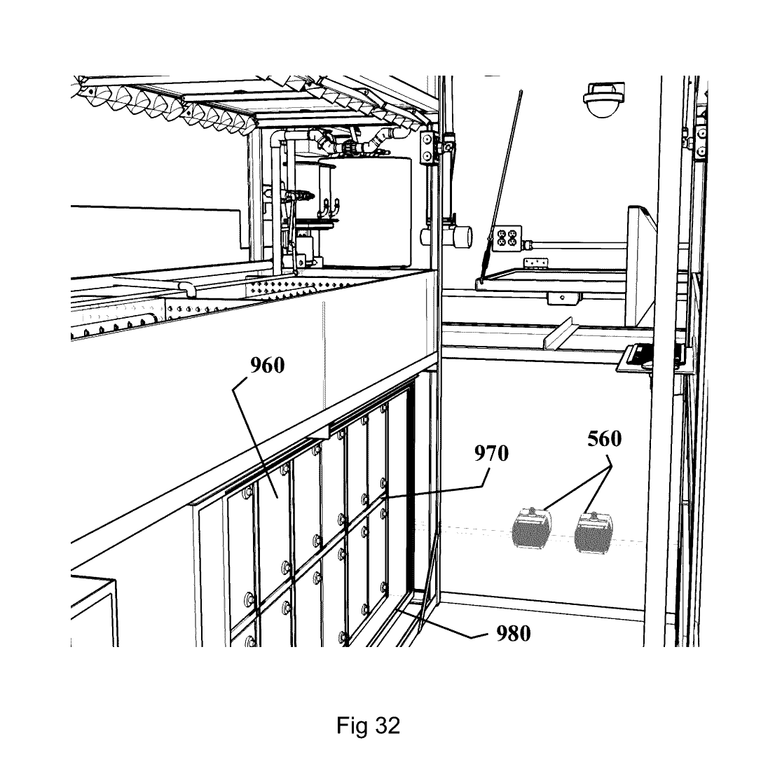

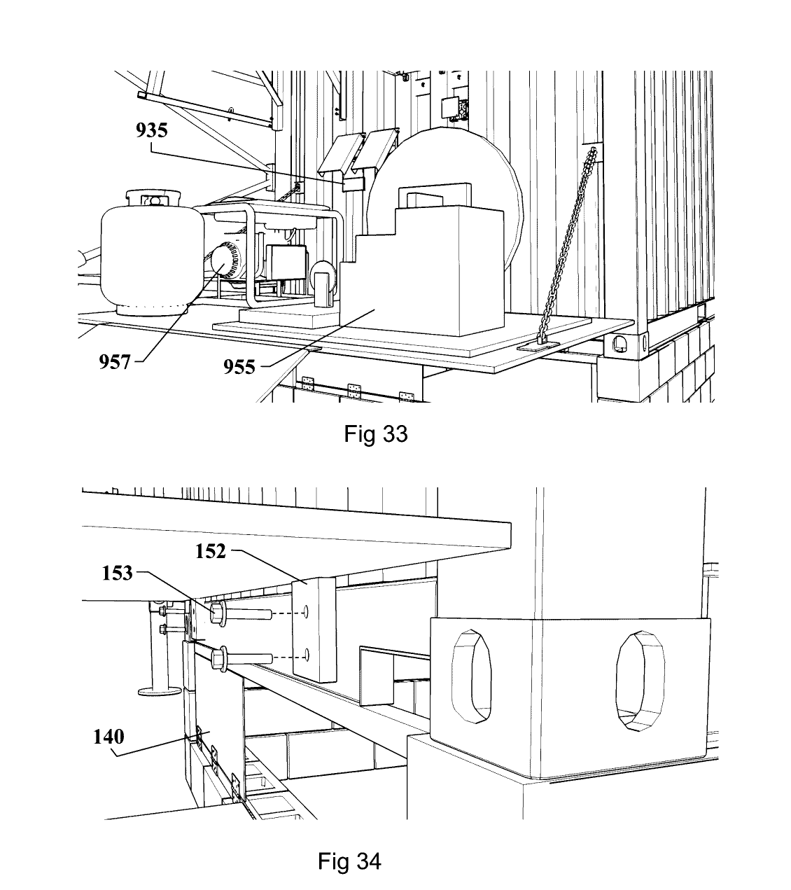

The PABS uses a highly advanced custom-designed integrated power system utilizing a combination of specialized components, which allows the entire PABS to operate either on- or off-grid. This power system meets the definition of “Microgrid” by virtue of the fact that it can operate in islanded mode (disconnected from the centralized grid via an automatic transfer switch). FIG. 30 shows the Microgrid power system 900 components including the Electrical Distribution System 902, the Solar PV Modules 930, the Wind Turbine Pole Mount 942, the PV micro inverters 925, the AC/DC load center 910, the energy storage device cabinet 980, the human power cycle generator 955, the grounding electrode 990, the grid connection inlet 995, the main inverter/charger 920 and the Main AC Electrical Distribution Panel 906. FIG. 31 shows a different view of the Microgrid power system 900 components including the Solar PV Modules 930, the PV Array Assembly 1000, the Wind Turbines 940, the satellite/cell phone antennae 1330, the Wind Turbine Mounting Pole 942, the Wind Turbine Bracing Assembly 945, the propane generator 957, the human powered cycle generator 955, the energy storage device cabinet 980, the grounding electrode 990, the energy storage combiner box 915, the main inverter/charger 920 and the Main AC Electrical Distribution Panel 906. FIG. 32 shows the energy storage devices configured in the energy device storage rack 970 inside the energy storage device cabinet 980. Also visible in this drawing are the water circulation pumps 560 inside the fish tank. The PABS is designed for off-grid use but is also designed to be grid-tied, if desired, as a backup power source. To ensure continued operation of the system when no grid connection is available and sunlight is diminished, the PABS comes equipped with two wind turbines, a propane generator 957, a human-powered generator cycle 955 and their inputs 935 to the power system, and also has multiple additional inputs for other additional backup power sources. (See FIG. 33). FIG. 34 shows the generator Platform Mounting Brace 152 and the Platform Mounting Bolts 153 as well as the Foundation Access Hatch 140. The user may elect for a diesel or other generator of up to 40 amps instead of or in addition to the propane generator. (See Microgrid: A group of interconnected loads and distributed energy resources (DER) with clearly defined electrical boundaries that acts as a single controllable entity with respect to the grid [and can] connect and disconnect from the grid to enable it to operate in both grid connected or island mode.” source: http://www.powerislandenergy.com/files/85581241.pdf;)

Islanding:

Islanding refers to the condition in which a distributed generator (DG) continues to power a location even though electrical grid power from the electric utility is no longer present. Islanding can be dangerous to utility workers, who may not realize that a circuit is still powered, and it may prevent automatic re-connection of devices. For that reason, distributed generators must detect islanding and immediately stop producing power; this is referred to as anti-islanding.)

Custom PV Array Single Axis Solar Tracking Racking System (with Rainwater Collection Pan):

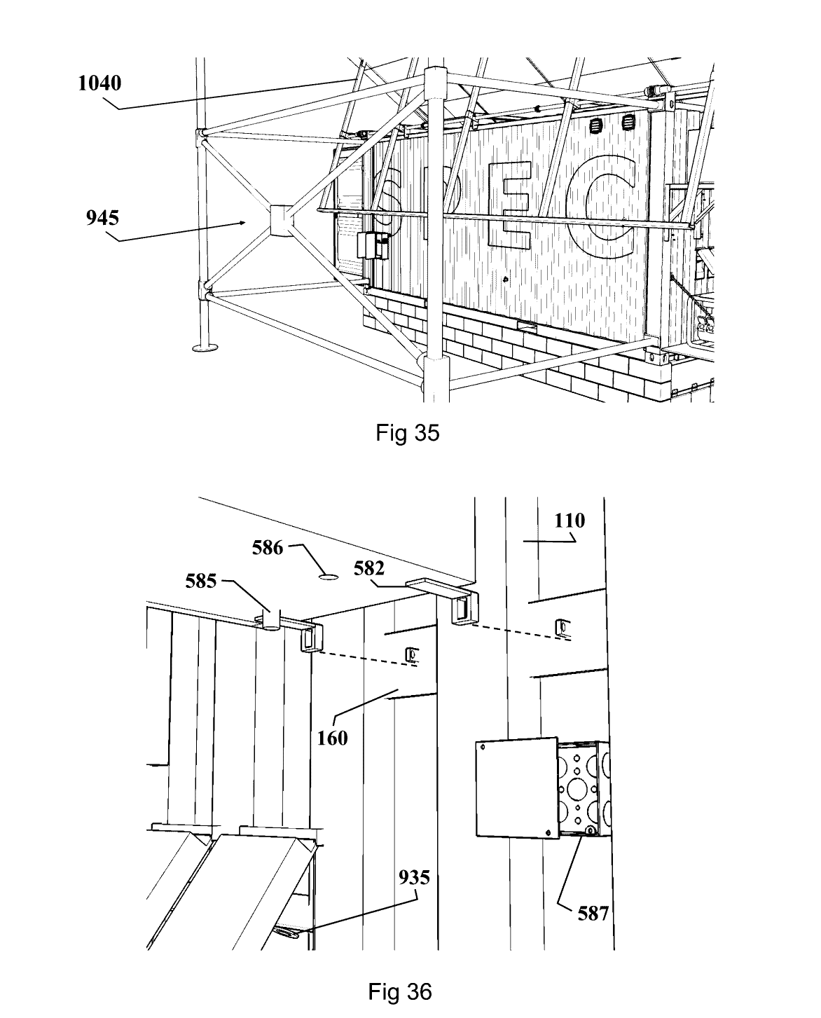

A PV racking system is custom designed to fit any standard shipping container configuration. The base rack provides both a structural foundation and connection point for the PV rack. Specially designed corner brackets attach (bolt) to the standard shipping container corner structural elements. Specially-designed interim brackets attach at intervals along the top rail of the container with through bolts. Each of these brackets provides a pivot hole accepting a standard 1.5 in. (3.81 cm) diameter steel pipe section. This pivot pipe allows the attached PV rack to pivot along the south side of the container. A PV rack is custom configured from industry-standard PV rail sections, to which the PV modules are connected. The PV rack has three vertical riser rails attached to allow elevation of one side (the free side opposite the pivot side) to be raised to any vertical position. This functionality allows the PV array angle to be seasonally adjusted to be perpendicular to the sun to maximize the intensity of the sun's light. The PV rack vertical riser assembly is raised by two DC electric winches mounted at the top corner brackets. Wire rope connects a base rail attached to the end of the vertical risers to the winches. Computer-controlled (or optionally manual) operation of the winches precisely raises and lowers the angle of the PV array. Marked settings assist the operator in knowing where the optimal angles for each season are located. The PV array is designed to catch and funnel rain water to the exterior water storage system. Two-millimeter thick aluminum sheets (collectively called the Rainwater Collection Pan) are mounted on the backside (underside) of the PV rack, which guide rainwater down to a custom gutter that is attached at the bottom of the array. The gutter connects to a flexible and extendable 3″ hose that leads to the rough filter and then to the exterior rainwater storage system (see above). FIG. 35 is a view of the exterior showing the PV Rack angle rail 1040 and the Wind Turbine bracing assembly 945. FIG. 36 shows a closer view of the exterior side.

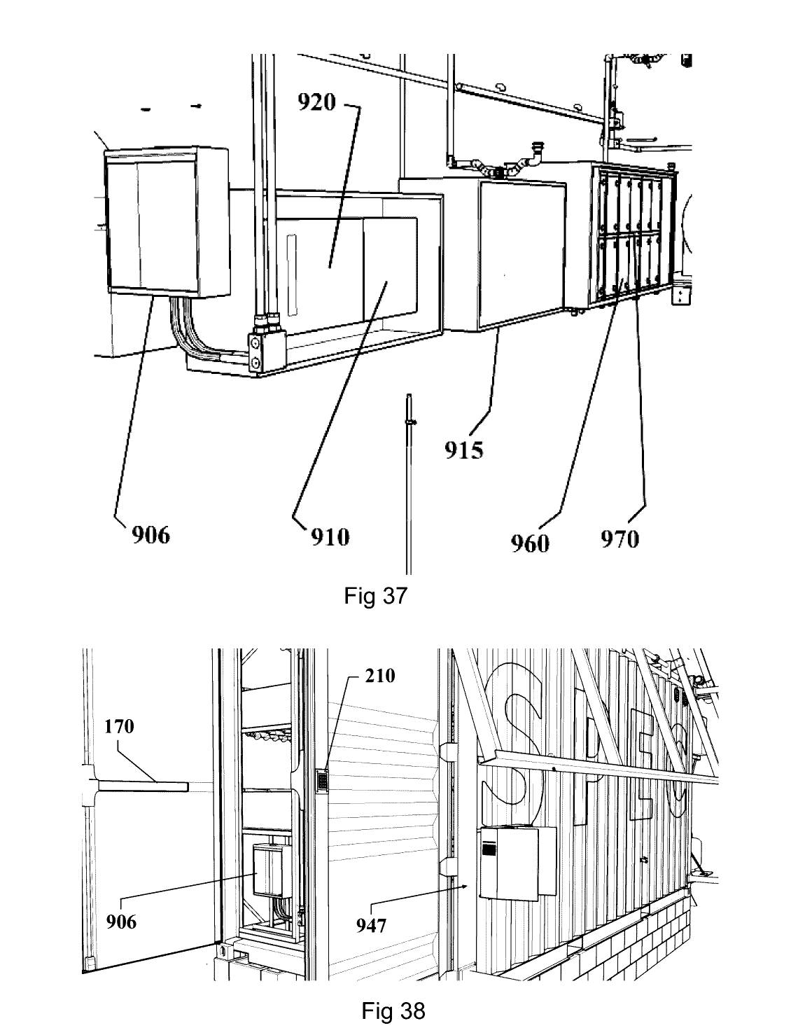

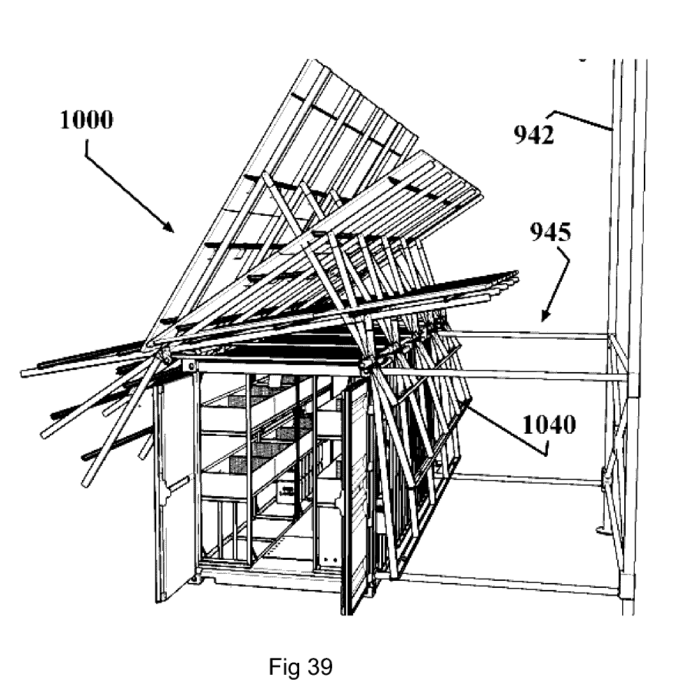

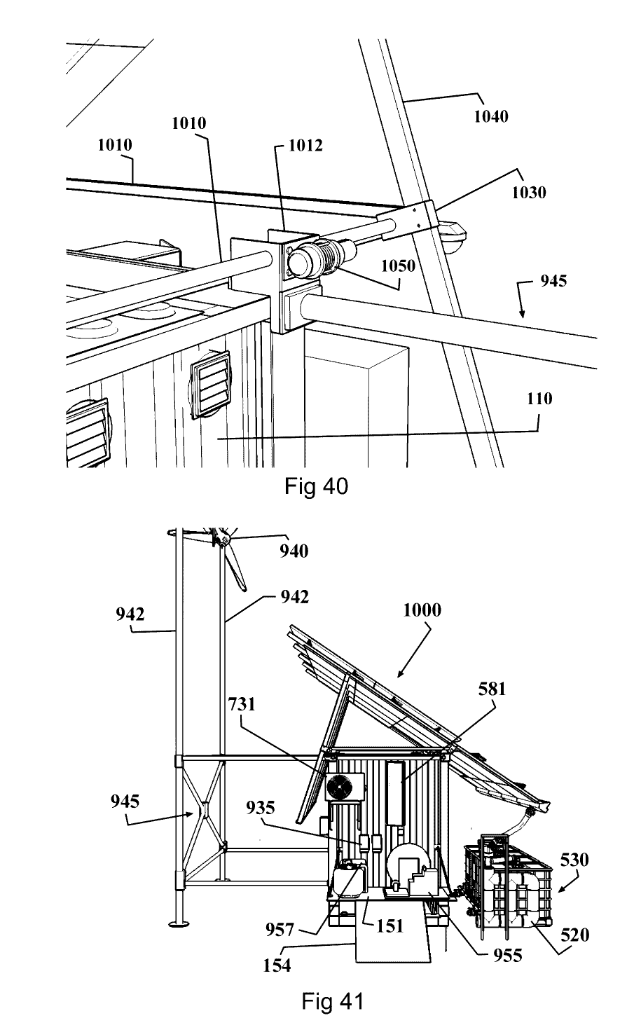

The PABS' Microgrid power system is comprised of:
1. AC/DC LOAD CENTER: The alternating current/direct current (AC/DC) Load Center is a power distribution center that provides circuit control and overcurrent protection (e.g. circuit breakers) for the PABS' power source inputs and output circuits, both AC and DC, and at 50 or 60 Hz, depending on the geographical location of the PABS and user needs. The AC/DC Load Center is a point at which the power sources and energy storage system couple and serve the loads for the PABS and/or the grid to which the PABS may be electrically connected. The PABS safely and efficiently produces, stores and supplies adequate power and energy for present and future needs.
2. AC LOAD CENTER: The AC Load Center is the PABS' main AC electrical panel. It receives its power from the AC/DC Load Center and is the point of connection for the AC loads for the PABS (e.g. lighting, pumps, fans, air conditioning, etc.). It provides circuit control and overcurrent protection for the PABS' loads.
3. GRID/HYBRID ENERGY STORAGE BASED INVERTER/CHARGER: The Grid/Hybrid Energy Storage Based Inverter/Charger is intended for both off-grid and grid-interactive (Grid/Hybrid) applications. It is designed to use energy storage devices to store energy, and then serve the PABS' DC loads or invert that energy to power the PABS' AC loads. It is also designed to utilize photovoltaic (PV), wind, grid, generator, human powered and other AC or DC sources to intelligently manage and power system loads, keep the energy storage devices charged and/or export energy to the grid. This grid/hybrid inverter/charger enables the user to achieve both grid-tied benefits with off-grid independence. This third-party unit has an output capacity of 8,000 W of continuous power at 33.3 amps AC at 120/240 V, 50 or 60 Hz. FIG. 37 shows the Main AC Electrical Distribution Panel 906, the main inverter/charger 920, the AC/DC load center 910, the energy storage combiner box 915, the energy storage devices 960 and the energy storage device rack 970. FIG. 38 is another exterior view showing the entrance to the system including the door lock Push Bar 170, the Main AC Electrical Distribution Panel 906, the door lock numerical pad 210 and the Wind Turbine Charge Controllers in their enclosure 947.
4. SOLAR PHOTOVOLTAICS: A customized, solar photovoltaic (PV) array (consisting of up to 24 third-party PV modules with two strings of 12 PV modules in each string) used as a power source generating on average 37.5 kWh at 5.5 peak sun hours per day (dependent upon geographic location). The PABS' PV system, which includes the PV modules, power inverters, racking, conductors, etc., utilizes micro-inverter technology (one inverter per PV module), which allows remote module-level monitoring via computer or smart phone from anywhere in the world with internet access. The micro-inverters provide a much safer system design than a central inverter system (one inverter for all 24 PV modules), since the current in the conductors (wires) from the micro inverter mounted under each PV module to the AC/DC Load Center is AC and not DC, mitigating the risks (e.g., arcing) associated with DC current. Micro-inverters maximize each panel's performance, whereas a central inverter does not. A micro-inverter based system also reduces total system energy losses associated with PV module or inverter failure in that if a PV module or micro-inverter should fail, the total system power output is only reduced by the proportional amount of the failed PV module or micro-inverter. In a central inverter system, PV module failure causes the entire string to stop producing power (one half the power output in the case of 24 PV modules with 12 PV modules in each string), and in most cases causes the central inverter to stop operating entirely, thereby shutting down the entire PV array's power output. If the central inverter fails in a central inverter system, the entire PV array's power output is also stopped. This avoidable risk of total failure by a central inverter system would jeopardize the health of the biological organisms within the PABS, since they are dependent on power. Thus, a micro-inverter system is used to ensure the PABS will operate reliably and safely off-grid, maximize system performance over time and minimize overall risk to users and biological organisms within the PABS. FIG. 39 shows the adjustable PV Solar Array 1000 illustrating the three seasonal angles. Also shown are the Wind Turbine Bracing Assembly 945, the PV Rack angle rail 1040 and the Wind Turbine Mounting Pole 942. FIG. 40 shows a close up of the custom steel brackets developed to secure the PV array to the PABS. PV array mounting brackets 1012 and winch 1050 are attached to the shipping container 110. Also visible in this drawing are the PV Base Rack 1010, the PV Rack angle adjustment 1030, the PV Rack angle rail 1040 and the Wind Turbine bracing assembly 945. FIG. 41 shows the PV array mounted to the roof of the PABS. The drawing shows the Wind Turbines 940, the Wind Turbine Mounting Pole 942, the Wind Turbine Bracing Assembly 945, the generator inlets 935, the generator platform 151, the propane generator 957, the human powered cycle generator 955, the removable platform ramp 154, the First Flush Diverter 520, the External Water Storage System 530, the Atmospheric Water Generator 581, the HVAC Mini-split exterior section 731 and the PV Solar Array 1000. The power output from the micro inverters is directed to the Energy Management Center before reaching the AC/DC load center.
5. ENERGY STORAGE: A system of lithium ferrous phosphate energy storage devices which stores generated electricity, powers the PABS' loads when needed (total standard storage capacity=47.6 kWh). The lifespan of the energy storage devices is estimated to be 20+ years. The energy storage capacity that comes standard is estimated to last for 36 hours without recharging (based on full operational loads), and additional storage capacity can be added. The energy storage devices are heat safe (not capable of thermal runaway under any circumstance), 100% recyclable, non-toxic, environmentally friendly, non-hazardous, moisture resistant, non-corrosive and do not vent any harmful gases, fumes, acid or chemicals.
6. SOFTWARE: Custom-built software optimizes the power consumption in real-time based on the power generation and energy storage, and is designed to maintain the most optimal user-specified growing conditions. This will include interface with remote electronic devices, control loads as well as power sources. The inverter/charger has the capability to intelligently manage the charging of the energy storage system, see below for details.
7. MONITORING SYSTEMS: Third party monitoring devices for power generation and energy storage are included in the system; one for the micro inverters, one for the energy storage based inverter/charger (which includes the AC/DC power inputs) and one for the energy management center. These monitoring systems include performance data and will alert users via email/text if these systems go offline or an event has been triggered, such as a malfunction. Event driven signal outputs can be directed to the Computer Control System (CCS) for integrated alerts. The Inverter/Charger and micro inverters are both UL 1741 and IEEE 1547 compliant.
8. EMERGENCY GENERATOR: An emergency backup generator also comes standard with the PABS unit. The third-party product we have selected for this system is a propane-fueled (low GHG emission) power generator. The propane generator uses 20 or 30 pound (9.07 kg or 13.60 kg) propane tanks similar to the kinds used for barbeque grills and camping equipment, and produces up to 5500 W of AC 120/240 V. Alternatively, the PABS can also use a diesel generator if desired, but diesel is not preferred because of its high GHG emissions. An equivalent diesel generator has a 30-gallon (113.56 l) tank and produces up to 6000 W of AC 120/240 V. The generator is connected to the AC/DC Load Center and is activated only when in islanded mode (disconnected from the grid) and when stored energy and local renewable generation is insufficient to meet load requirements.
9. WIND TURBINE: Two 1500 kW DC wind turbine power generators attached to the PABS also come standard. These third-party products are connected to charge controllers and the AC/DC Load Center via the energy management system (EMS), where the overcurrent devices are located, and are used to charge the energy storage devices. The wind turbines can generate up to 36 kWh per day, depending on weather conditions. Unlike solar, which works only during daylight hours, wind turbines can generate power 24 hours per day if there is sufficient wind.
10. HUMAN-POWERED CYCLE: A human-powered cycle (HPC) generator also comes standard with the PABS. This third-party power generator is connected to the AC/DC Load Center via the energy management system (EMS) and is used to charge the energy storage devices. Like the propane generator, the HPC generator is intended as an emergency backup or supplemental power source. It comes with the PABS but must be set up and operated outside the PABS container. Multiple power input ports in the walls of the container allow the generator to be easily plugged into the PABS' electrical system.
11. ENERGY MANAGEMENT SYSTEM: The PABS comes equipped with a third-party energy management system which enables the PABS to receive, integrate and regulate power from numerous input sources, including the solar PV, wind turbines, human-powered cycle generator, or other power sources including, if desired, a grid connection. The EMS allows remote monitoring, power balancing and load management. The third-party energy management center selected for this design is approximately 5 ft. (1.52 m)×2 ft. (0.60 m)×1 ft. (0.30 m) and is housed inside a nematite enclosure and mounted to the exterior of the shipping container in the same fashion to how the AWG is mounted, as explained in paragraph [0072] above and shown in FIGS. 11 and 12.

Sensor System:

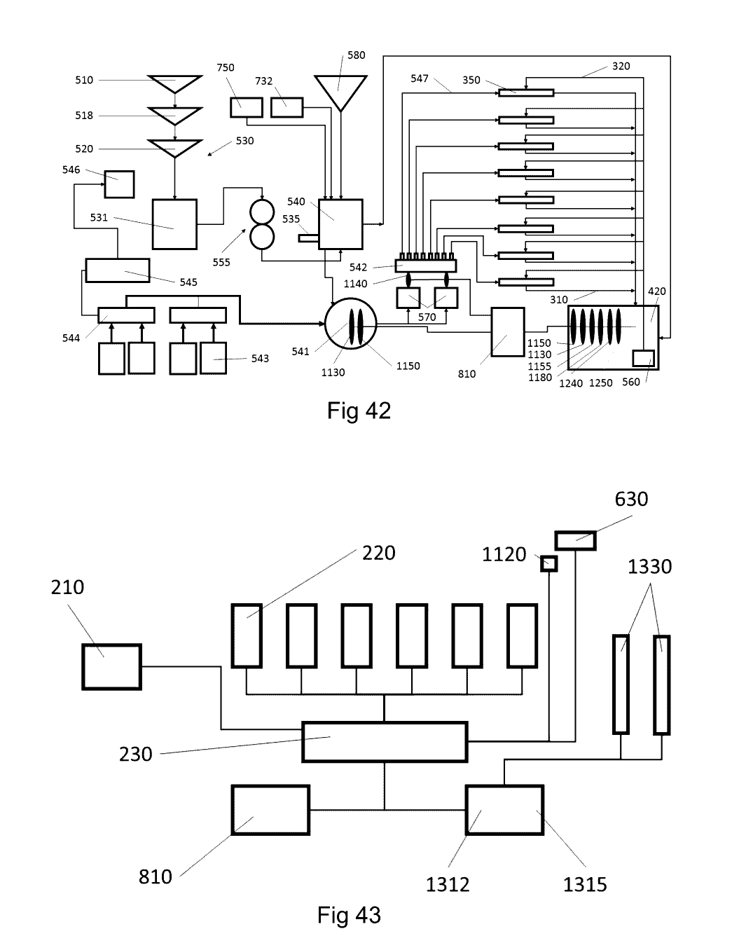

The PABS is equipped with multiple sensors which measure and provide real-time data to the Computer Control System (CCS) regarding variable parameters and environmental and system conditions that include rainfall rate and accumulation, solar irradiation and wind speed, water levels, temperature and humidity, dissolved oxygen (DO), pH and electrical conductivity (EC), carbon dioxide (CO₂) and oxygen (O₂), nitrogen, potassium and phosphorus (NPK), ammonia, and light (PAR). Additional sensors may be added to monitor all other essential elements of plant and fish biosystems. FIG. 42. is a diagram of the Water System 500 showing the Exterior Water Storage System 530 comprised of the Rainwater Collection Pan 510, the Leaf Guard Filter 518, the First Flush Diverter 520 and the IBC totes 531. Also shown are the water filters 555, the internal auxiliary water tank 540, the input to the auxiliary water tank 535, the Atmospheric Water Generator 580, the HVAC mini-split interior section 732, plastic tubing 547, the grow beds 350, the fill pipes 320, the drain pipes 310, the fish tank 420, the nutrient feed tank 541, the nutrient reservoirs 543, the dosing controllers 544, the nutrient injection base unit and the nutrient injection system display 546. Also shown are sensors for water level 1130, pH 1150, Dissolved Oxygen 1155, Nitrogen, Potassium and Phosphorous 1240, ammonia/ammonium 1250 and circulation 560 and drip 570 pumps. Because this diagram is meant to show the Water System 500, not shown in this diagram are the numerous other connections to the PC. Not all fluid sensors are shown and additional sensors can be added with connection to the PC. Computer-controlled flow valves are not shown and all connect to the PC and these do affect the flow of water within the system.

Security System and Access Control:

FIG. 43 is a diagram of the Security System 200 showing the security cameras 220, the door locks 210, the DVR unit 230, the Personal Computer 810, the security light 630 and motion detector 1120, the satellite 1315 and cell 1312 phones and antennae 1330. The PABS security system has the following features:
1 The doors to the container have been modified with custom door locks.
2 A digital keypad has been added to the exterior of the door to control the custom door locks. This keypad and the door lock controls and motor are powered by the PABS' Microgrid power system.
3 The doors have been modified with interior push bars to open the doors from the inside, to prevent anyone from being accidentally trapped within the container.
4 A video surveillance system includes both interior and exterior cameras for complete ability to monitor the areas immediately surrounding the PABS as well as the activity within the PABS.
5 Interior cameras include a 360° pan/tilt/zoom function with infra-red and night vision capabilities that permit close observation of the growing environment, fish and plants at all times.
6 Exterior cameras include night vision and are water/temperature resistance.
7 The entire surveillance system is accessible from the internet and through mobile devices.
8 A digital recorder is activated by motion detector or by user control, or on a schedule.
9 All components of the security system are tracked by the Computer Control System (CCS) to provide detailed access and real-time security reports

Communications System:

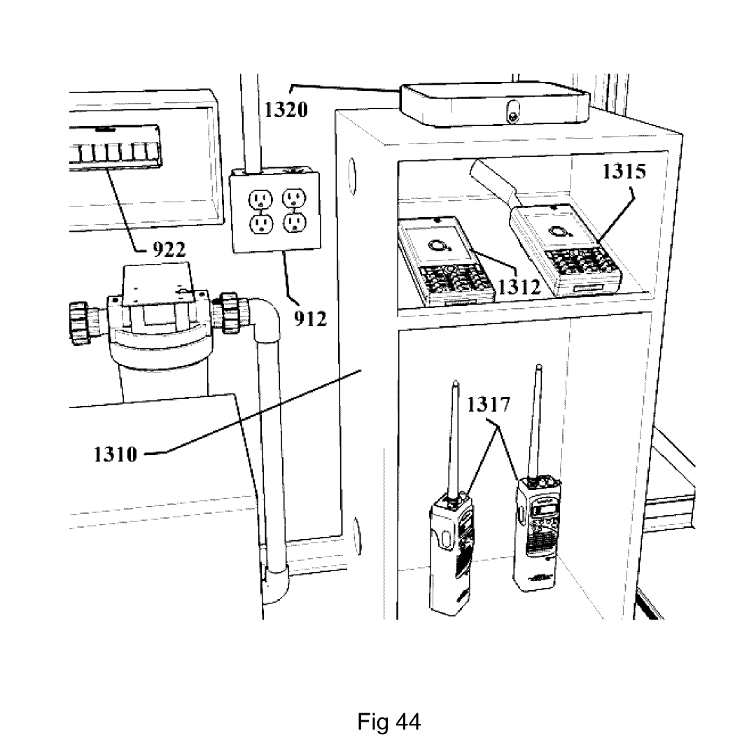

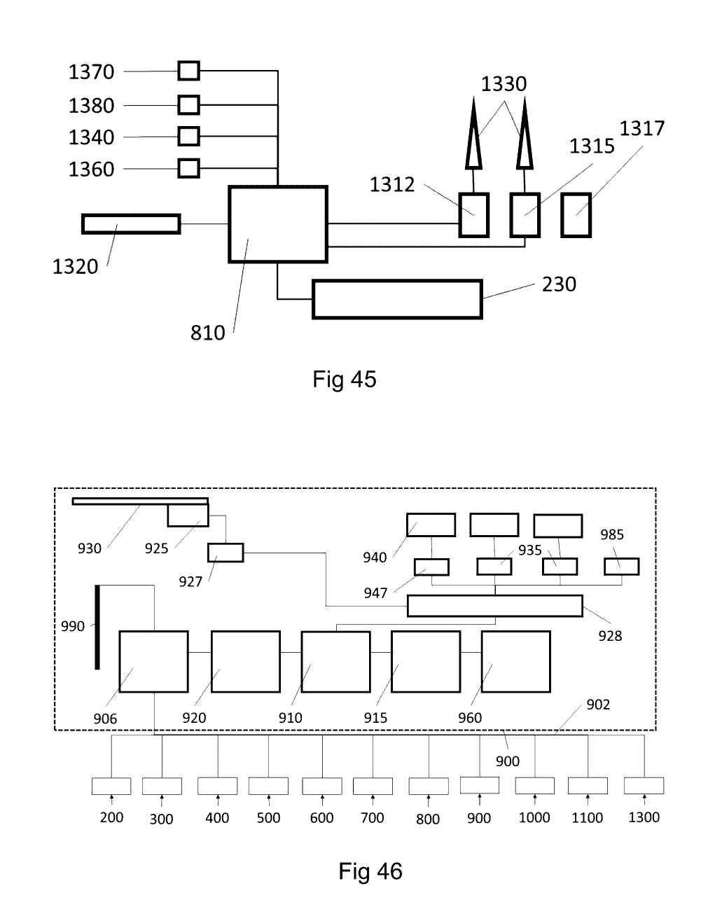

The PABS comes standard with a third-party cellular telephone and the user can opt for a third-party satellite phone instead of or in addition to the cellular phone. The cell phone (and/or satellite phone) is connected to the Computer Control System (CCS) to communicate real-time systems information, and is connected to an external antenna for better signal transmission and reception. The PABS also includes a Wi-Fi router/extender to enable wireless internet connectivity to any local Wi-Fi source. In addition, input and output CAT-5 internet ports for hardline network connectivity are available on the exterior of the PABS container and connect to the router/extender. FIG. 44 shows the communications center cabinet 1310 under the north grow bed 350. Also shown are the Wi-Fi Router/Extender 1320, the satellite phone 1315, cellular phone 1312 and portable radios 1317. Also shown in this drawing are the power relay board 922 and a GFCI (ground-fault circuit interrupter) power outlet 912. FIG. 45 is a diagram of the communications system 1300 showing the personal computer (PC) tower 810, the Wi-Fi router/extender 1320, the DVR 230, the cell phone 1312) and satellite phone 1315, the cell/sat. antennae 1330, portable radios 1317 and connections for HDMI 1370, USB 1380, CATS 1340 and RF 1360.

Construction and Deployment Process.

The PABS is constructed and deployed in a several step process for each unit. Each of the numbered steps described below is elaborated upon in the following sections:
1 Identify unit and geographic location parameters and component specifications (standard or customized)
2 Custom design of systems based upon local weather conditions
3 Procure components
4 Assemble components
5 Quality Assurance/Quality Control
6 System Documentation
7 Transportation Logistics
8 Onsite Setup and Installation and testing
9 Operations and performance evaluation
10 Support and Maintenance
11 Data Collection and Analysis

Identify Unit Parameters and Component Specifications (Standard or Customized).

Each model of the PABS has a standard configuration of equipment, but also equipment options and modifications can be added in addition to the core equipment that makes the system operate within parameters. For example, a user may want an extra backup water or air pump beyond the single backup for each that is standard, extra sensors, security cameras, or a different model or manufacturer of some system component. Any adjustments to the equipment can require adjustments to other elements of the system, and therefore engineering review takes place whenever there is any modification from the standard specifications. In addition, in this stage the user selects what size container they want, with the 20 ft. (6.09 m) containers being standard and 40 ft. (12.19 m) or 50 ft. (15.24 m) containers being optional. The additional footage within the larger containers can be configured for any number of purposes desired by the user, from bringing the external water storage system inside the container to a full living quarters, food preparation/packaging station or retail shop. Multiple container configurations are also available.

Custom Design of Systems Based Upon Local Weather Conditions.

Utilizing weather location profiles available from the USGS, our engineers run an analysis of the weather profile to determine any needed adjustments to the design. For example, in a low rain-fall location, additional water storage capacity may be necessary, if the relative humidity is too low for the atmospheric water generator to provide adequate water for the system.

Procure Components.

Once the design is chosen and components selected, the components are then procured from their sources.

Assemble Components.

All components need to be installed into the system. Some components require degrees of fabrication. For example, the custom grow bed frame for the unit will be pre-built and assembled on-site with materials procured to specifications.

Quality Assurance/Quality Control.

All components are tested and the entire system is thoroughly tested using multiple variable parameters to ensure operating stability.

System Documentation.

The system is thoroughly documented in a comprehensive on-line and hard copy User's Manual.

Transportation Logistics.

The PABS is disassembled at manufacturing facilities and all parts labeled for re-assembly and an inventory manifest documented. The PABS is designed to ship all required materials within the container and assembled on site. Coordination of delivery utilizing commercial transportation logistics firms will be provided.

Onsite Setup and Installation and Testing.

Customers may set-up themselves or utilize vendor services for setup and installation. When the vendor provides installation, testing of the system is conducted and the cycling process begun.

Operations and Performance Evaluation.

The vendor maintains performance data on the PABS and evaluates it.

Support and Maintenance.

The vendor provides 24/7 support and maintenance for the PABS' operations as needed by the customer.

Data Collection and Analysis.

The vendor uses data feedback from the PABS units to prepare reports on their collective effectiveness and efficiency and conducts analysis periodically to improve future designs.

Market Applications.

The innovative PABS system has numerous market applications, including but not limited to:
1 Education
   a. Educational infrastructure
   b. Cafeteria supply
   c. Scientific research
   d. Revenue generation/community supply opportunities
2 Military
   a. Remote operations
   b. Bases and Camps
   c. Aid to communities, domestic and foreign
3 Residential
   a. Homeowners
   b. Survivalists
   c. Hobbyists
4 Commercial
   a. Commercial farmers
   b. Organic farmers
   c. Restaurants
   d. Grocery Markets
   e. Value-Added Producers
   f. Corporations (large employers with onsite food preparation)
   g. Hotels
5 Industrial
   a. Prisons
   b. Hospitals
   c. Schools
6 Emergency/Disaster relief
   a. Refugee camps
   b. Disaster areas
   c. Multiple methods of delivery

Novel and Inventive Aspects:

While Aquaponics and hydroponics as growing techniques are not new, the overall integrated system we have designed is novel and inventive as now explained feature by feature:
1 Containerized Aquaponics: While shipping containers are in use for growing systems generally, there are a number of aspects to our use of the shipping container as a structure which are novel and inventive. To wit, while aquaponic systems have been previously developed in shipping containers, the off-grid capability of this unit is unique. While other containerized aquaponic designs mention the possibility of powering their system by solar power or using energy storage, none actually incorporated renewable generation into the design of the core system itself. While aquaponic systems have been previously developed in shipping containers, high level of automation offered by the PABS unit is unique. While aquaponic systems and hydroponic systems have been previously developed in shipping containers, the hybrid aquaponic/hydroponic mode (with dual root-zone) capability of this unit's design is unique. Furthermore, the three-level Dispersion Pipe assembly is another novel element of the design not seen in any other similar invention.
2 Customized Grow Beds and Piping/Pumping System: While Aquaponics grow beds are in use elsewhere, there are a number of aspects to our grow beds which are novel and inventive and not seen in any prior similar inventions. The grow beds are situated to maximize allowable space within an original (custom-designed) steel. Grow beds are custom designed a) for maximum yield given the specific space constraints of the PABS, b) to optimize phased pump and drain operations to circulate water level in the fish tank, c) to optimize growing space relative to the size of the fish tank, d) grow beds are custom-manufactured to specific design and performance specifications, using ½ in. (1.27 cm) thick Plexiglas or similar material (nontoxic to plants and fish), and e) each grow bed is divided into segments for structural and operational purposes. Grow bed plumbing/piping system uses a customized, gravity operated auto-siphon design. Each bed is filled and drained in a sequence relative to the others using a motorized valve, operated by the PC. The timing is adjusted to maximize aerobic cycling. The three-tiered fish-water Drop Pipe and Dispersion Pipe assembly is also unique because it allows extreme user flexibility to fill the grow beds from bottom, middle, top or combinations thereof (this increases the probability of even distribution of the bacteria colonies within the media than if only a single fill point were used as done in other inventions). The PABS grow beds can be configured by the user to be either single level (lower bed only) or double bed (lower and upper beds). Each grow bed section can be configured separately, so it is possible to have single beds in some locations and double beds in others.
3 Multiple Water Tanks: Unlike other inventions which rely on water supplied by municipal water systems or unspecified and unclaimed (not part of their invention) sources, the PABS includes water capture, generation and storage capacity as part of its core design to create a truly renewable and off-grid system. Moreover, the PABS automatic refill functionality facilitated by the interior auxiliary water storage tank also ensures that water refilled into the fish tank is the same temperature while at the same time automating what is otherwise a user-required activity of topping off the fish tank on a daily basis.
4 Computer Control System: The PABS includes a Computer Control System (CCS) that integrates all the electronic and physical systems of the PABS to provide a comprehensive and user-friendly interface that allows complete monitoring and control over virtually every aspect of the PABS. The level of computer control over the PABS' system is beyond that provided by any other similar invention because it integrates management of power, aquaponic, hydroponic, environmental, security and communications systems.
5 Customized PV Rack Mounting and Rainwater Collection System: This customized rack mounting solution is designed for maximum energy efficiency and security. The PV array is also designed to capture rainwater and transport it to the rainwater collection tank (described further below). For an aquaponic system of PABS' nature, the inclusion of a solar PV array is unique. Further, the design of this array is especially unique because it includes a) seasonal adjustability with winch-assistance; b) mounted to the roof of the container with customer-designed and manufactured brackets; c) includes a water rain catchment system that delivers water to the exterior water storage system (EWSS). These are features not found in any other similar invention.
6 Custom Rainwater Collection/Storage System: The PABS incorporates into its core design a water collection, capture and storage system comprised of multiple storage tanks, which are calculated to provide enough rain water storage capacity to operate a typical PABS for one year completely off the grid and municipal water system. Part of the uniqueness of this complete water system is its inclusion of a three stage cleaning/filtration process: 1) debris filter; 2) first flush diverter; and 3) carbon filtration as described herein.
7 Customized Adjustable Lighting System: To balance the power consumption requirements of the system against the generation and storage capabilities of the system, the lighting system has several unique components. The PABS uses low-wattage Light Emitting Diode (LED) lights providing the exact spectrum of light required by plants for optimal growth and development. The PABS has the ability to automatically adjust the intensity of LED lights to enable further power reduction when necessary to ensure system power balance. The PABS offers automatic dimming by computer control when power storage is at the low-power set point and includes individual and group lighting controls to enable multiple options on growing configurations (e.g., cohort crop, permanent harvest, mixed crops, etc.). No other similar growing system inventions have LED grow lights with the ability to adjust their intensity based on energy system parameters.
8 Microgrid Power System: The electrical power system of the PABS is designed as a Microgrid. While Microgrids themselves are not unique, no other containerized growing system has its own Microgrid incorporated as a critical core element of the design. The Microgrid has been custom-designed to handle the specific power loads of the PABS unit to ensure continued operation while off-grid with minimal operator action or attendance required. The Microgrid includes an Energy Management System (EMS) and a third-party power management device, which allows multiple additional power source inputs. Another unique feature is the power storage system which includes 14 lithium ferrous phosphate storage devices that are 100% recyclable, heat safe and non-toxic, unlike traditional lead-acid batteries. A further novel aspect of the Microgrid power system is the redundant emergency backup power generators (one propane generator, one human-powered cycle generator) that come standard with the PABS unit. FIG. 46 is a diagram of the Microgrid power system 900 providing power to the other subsystems. Shown are the solar PV modules 930, the micro inverters 925, the junction box 927, the Wind Turbines 940, the Wind Turbine Charge Controllers 947, the generator power inlets 935) the grid connection inlet 985, the energy management center 928, the grounding electrode 990, the main AC electrical distribution panel 906, the main inverter/charger 920, AC/DC load center 910, the energy storage combiner box 915, the energy storage devices 960 and the Electrical Distribution System 902. The other subsystems are identified: the Security System 200, the Grow Bed System 300, the Fish Biosystem 400, the Water System 500, the Lighting System 600, the Air Control System 700, the Computer Control System 800, the Microgrid Power System 900 (the electrical distribution system is part of the Microgrid Power System 900), the PV Array Assembly 1000, the Sensor System 1100 and the Communications System 1300.
9 Energy Recovery Ventilator (ERV): While other container systems utilize air conditioning and/or heating to maintain the proper conditions for growing plants, none has incorporated an Energy Recovery Ventilator (ERV) as a critical core element of the design. The ERV heat recovery core is made of a membrane that allows moisture, as well as heat, to transfer to the incoming or outgoing air stream. This key feature ensures regular and necessary air exchanges occur even when the unit is unattended for many days, while also significantly reducing the energy required to maintain the proper environmental conditions inside the container when compared to systems without an ERV. The ERV also contains MERV8 and MERV13 replaceable air filters.
10 Security System: A visual security system designed for and used in a shipping container grow room is a novel and inventive application that no other containerized growing system offers. This subsystem allows the grower to monitor the interior and exterior of his/her farm remotely. A Pan-Tilt-Zoom IR/night-vision camera is included on the interior of the unit to allow detailed observation of the plants and fish whether the lights are on or off. If a local internet data connection is unavailable, the cell or satellite phone of the Communications System can provide real-time access to the security monitoring functions of the PABS.
11 Atmospheric Water Generator: An atmospheric water generator is another unique feature not found in any other similar invention. The atmospheric water generator generates up to 8 gallons (30.28 l) of water from the atmosphere per day and is powered by the Microgrid system.
12 Sensor System: The PABS is equipped with multiple sensors which measure and provide real-time data to the Computer Control System (CCS) regarding variable parameters and environmental and system conditions that include rainfall rate and accumulation, solar irradiation and wind speed, water levels, temperature and humidity, dissolved oxygen (DO), pH and electrical conductivity (EC), carbon dioxide (CO₂) and oxygen (O₂), nitrogen, potassium and phosphorus (NPK), ammonia/ammonium (NH₃/NH₄) and light (PAR). Additional sensors may be added to monitor all other essential elements of plant and fish biosystems.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

### REFERENCES

Timmons, Michael and Ebeling, James. “Recirculating Aquaculture 3^{rd} Edition”, 2013).
Hancock, Roger. “Water and Energy Conservation Grow System: Aquaponics and Aeroponics with a Cycle Timer”, Senior Project, Electrical Engineering Department, California Polytechnic State University, 2012.
Hambrey, Dr. John. “Aquaponics Research Project”, Commissioned Report for New Zealand Aid Programme, Ministry of Foreign Affairs and Trade, 2013.
Food & Water Watch, “Water Usage in Recirculating Aquaculture/Aquaponic Systems”, Fact Sheet August 2009.
Bernstein, Sylvia. “Aquaponic Gardening”, 2013, p. 123

We claim:

1. A portable, self-contained, self-sustaining, self-powered, self-watered growing system comprising:
a modified intermodal shipping container;
a computer control system;
a microgrid electric power system;
a photovoltaic racking system including photovoltaic solar cells disposed on the intermodal shipping container; and
a hybrid aquaponic hydroponic system with aquaponic, hydroponic and combination aquaponic-hydroponic operating modes disposed within the intermodal shipping container comprising:
a recirculating water system;
a plant feed control system;
a multi-mode lighting system; and
an environmental control system.

2. The growing system according to claim 1 further comprising a security system.

3. The growing system according to claim 1 further comprising a communications system including an antenna.

4. The growing system according to claim 1, wherein said hybrid aquaponic hydroponic system further comprises an array of environmental sensors.

5. The growing system according to claim 4, wherein the array of environmental sensors comprises at least one of rainfall rate and accumulation sensors, solar irradiation sensors, wind speed sensors, water level sensors, temperature and humidity sensors, pH sensors and electrical conductivity sensors, dissolved oxygen sensors, carbon dioxide sensors, oxygen sensors, nitrogen, potassium and phosphorus sensors, ammonia/ammonium sensors and photosynthetically active light sensors.

6. The growing system according to claim 1, wherein said hybrid aquaponic hydroponic system further comprised of a two-tiered horizontal grow bed system fed by the recirculating water system.

7. The growing system according to claim 1, wherein said hybrid aquaponic hydroponic system can be operated as an aquaponic system with a single root zone, a hydroponic system with a single root zone, or a hybrid aquaponic-hydroponic system with a dual-root zone

8. The growing system according to claim 1, wherein the recirculating water system comprises a fish tank, an exterior water storage system, a rainwater collection system, a piping system, an atmospheric water generator, and a nutrient feed tank.

9. The growing system according to claim 8, wherein the recirculating water system further comprises a primary flush filter, an interior auxiliary water storage tank, a first flush diverter, a condensation drain tube from the evaporator coil of the HVAC system into the indoor auxiliary water tank, pumps for moving fluids and, a grow bed auto-siphon drain system.

10. The growing system according to claim 9, wherein the first flush diverter comprises of a fill chamber, a floating ball inside the fill chamber, a valve seat for the floating ball to block the diverter and an adjustable slow-release drain hole.

11. The growing system according to claim 1, wherein said plant feed control system is comprised of a nutrient injection system, a nutrient feed tank in fluidic communication with the recirculating water system, a manifold and flow control valves in fluidic communication with the nutrient feed tank, and a dispersion assembly.

12. The growing system according to claim 11, wherein the dispersion assembly is comprised of a vertical “drop” pipe with incoming fish water or plant feed solution, depending upon operating modes, descending into the grow bed with horizontal pipes extending from the drop pipe, wherein each horizontal pipe is capped at the end, contains numerous outlet perforations and is connected to the drop pipe via a computer-controlled flow valve.

13. The growing system according to claim 1, wherein said multi-mode lighting system comprises a plurality of Light Emitting Diode grow lighting fixtures mounted over the grow beds, and Light Emitting Diode ambient interior lighting fixtures, at least one ambient white and at least one green, the ambient white fixture for working in the system when the system is not in operation and the green fixture for working when the system is in operation but the grow lights are off, wherein the lighting fixtures can be controlled individually to maximize flexibility in configuration and operation of the system.

14. The growing system according to claim 1, wherein the photovoltaic racking system further comprises mounting brackets, industry-standard array rails and fittings, winches with winch cables and a pivot bar which form a single-axis solar tracking system allowing the photovoltaic solar cells to be adjusted seasonally to maximize reception of solar irradiation throughout the year.

15. The growing system according to claim 1, wherein the rainwater collection system comprises collector sections attached to the photovoltaic racking array, a rain gutter attached to the collector sections so that rain falling on the photovoltaic solar cells drops to the collector sections and is guided to the rain gutter and captured for use.
